(19) United States
(12) Patent Application Publication
(10) Pub. No.: US 2025/0156063 A1
(43) Pub. Date: May 15, 2025

(54) MAPPING TOUCH AND GESTURE CONTROLS TO INCREASE CONTROL OPTIONS

(71) Applicant: QUALCOMM Incorporated, San Diego, CA (US)

(72) Inventors: Hitesh Venkata RACHAKONDA, Hyderabad (IN); Ankita CHAUDHA, Hyderabad (IN)

(21) Appl. No.: 18/510,478

(22) Filed: Nov. 15, 2023

(51) Int. Cl. G06F 3/0488; G06F 3/01; H04W 4/80

(52) U.S. Cl. CPC G06F 3/0488; G06F 3/011; G06F 3/017; H04W 4/80; G06F 2203/04808

(57) ABSTRACT

Disclosed are systems and techniques for controlling a device. For example, a computing device can detect, based on sensor data from one or more sensors, a first hand gesture of a plurality of first hand gestures of a user. The computing device can determine a first settings list of a plurality of settings lists based on the first hand gesture. The first settings list includes a plurality of control options. The computing device can detect a control gesture of a plurality of control gestures by the user. Each control gesture of the plurality of control gestures is associated with a different control option of the plurality of control options. The computing device can determine a first control option of the plurality of control options of the first settings list based on the control gesture. The computing device can enable the first control option to control the apparatus.

### FIELD

The present disclosure generally relates to control options for devices. For example, aspects of the present disclosure relate to mapping touch and gesture controls to increase control options.

### BACKGROUND

An extended reality (XR) (e.g., virtual reality, augmented reality, mixed reality) system or device can provide a user with a virtual experience (e.g., an XR experience) by immersing the user in a completely virtual environment (made up of virtual content) and/or can provide the user with an augmented or mixed reality experience by combining a real-world or physical environment with a virtual environment. XR systems or devices can include virtual reality (VR) systems facilitating interactions with VR environments, augmented reality (AR) systems facilitating interactions with AR environments, mixed reality (MR) systems facilitating interactions with MR environments, and/or other XR systems. Examples of an XR system or device includes a head-mounted display (HMD), such as an AR/VR HMD, which may be in the form of smart glasses. An XR system or device (e.g., an HMD) may be paired or implemented with a touch pad, which may be used by a user to control their XR experiences from the XR system or device.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, apparatuses, methods and computer-readable media for mapping touch and gesture controls to increase control options. According to at least one example, an apparatus for enabling one or more control options is provided. The apparatus includes at least one memory and at least one processor coupled to the at least one memory and configured to: detect, based on sensor data from one or more sensors, a first hand gesture of a plurality of first hand gestures of a user; determine a first settings list of a plurality of settings lists based on the first hand gesture, wherein the first settings list comprises a plurality of control options; detect a control gesture of a plurality of control gestures by the user, wherein each control gesture of the plurality of control gestures is associated with a different control option of the plurality of control options; determine a first control option of the plurality of control options of the first settings list based on the control gesture; and enable the first control option to control the apparatus.

In another illustrative example, a method is provided for controlling a device, such as an XR device. The method includes: detecting, using one or more sensors, a first hand gesture of a plurality of first hand gestures of a user; determining, by one or more processors, a first settings list of a plurality of settings lists based on the first hand gesture, wherein the first settings list comprises a plurality of control options; detecting a control gesture of a plurality of control gestures by the user, wherein each control gesture of the plurality of control gestures is associated with a different control option of the plurality of control options; determining, by the one or more processors, a first control option of the plurality of control options of the first settings list based on the control gesture; and enabling, by the one or more processors, the first control option to control the device.

In another illustrative example, a non-transitory computer-readable medium of a device is provided having stored thereon instructions that, when executed by one or more processors, cause the one or more processors to: detect, based on sensor data from one or more sensors, a first hand gesture of a plurality of first hand gestures of a user; determine a first settings list of a plurality of settings lists based on the first hand gesture, wherein the first settings list comprises a plurality of control options; detect a control gesture of a plurality of control gestures by the user, wherein each control gesture of the plurality of control gestures is associated with a different control option of the plurality of control options; determine a first control option of the plurality of control options of the first settings list based on the control gesture; and enable the first control option to control the device.

In another illustrative example, an apparatus is provided that includes: means for detecting, based on sensor data from one or more sensors, a first hand gesture of a plurality of first hand gestures of a user; means for determining a first settings list of a plurality of settings lists based on the first hand gesture, wherein the first settings list comprises a plurality of control options; means for detecting a control gesture of a plurality of control gestures by the user, wherein each control gesture of the plurality of control gestures is associated with a different control option of the plurality of control options; means for determining a first control option of the plurality of control options of the first settings list based on the control gesture; and means for enabling the first control option to control the device.

Aspects generally include a method, apparatus, system, computer program product, non-transitory computer-readable medium, user device, user equipment, wireless communication device, and/or processing system as substantially described with reference to and as illustrated by the drawings and specification.

In some aspects, one or more of the apparatuses described herein can include or be part of an extended reality device (e.g., a virtual reality (VR) device, an augmented reality (AR) device, or a mixed reality (MR) device), a mobile device (e.g., a mobile telephone or other mobile device), a wearable device (e.g., a network-connected watch or other wearable device), a personal computer, a laptop computer, a server computer, a television, a video game console, or other device. In some aspects, the apparatus further includes at least one camera for capturing one or more images or video frames. For example, the apparatus can include a camera (e.g., an RGB camera) or multiple cameras for capturing one or more images and/or one or more videos including video frames. In some aspects, the apparatus includes a display for displaying one or more images, videos, notifications, or other displayable data. In some aspects, the apparatus includes a transmitter configured to transmit data or information over a transmission medium to at least one device. In some aspects, the processor includes a central processing unit (CPU), a graphics processing unit (GPU), a neural processing unit (NPU), or other processing device or component.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

Other objects and advantages associated with the aspects disclosed herein will be apparent to those skilled in the art based on the accompanying drawings and detailed description.

### BRIEF DESCRIPTION OF THE DRAWINGS

Illustrative aspects of the present application are described in detail below with reference to the following figures:

FIG. 1 is a block diagram illustrating an architecture of an image capture and processing system, in accordance with aspects of the present disclosure.

FIG. 2 is a diagram illustrating an architecture of an example extended reality (XR) system, in accordance with some aspects of the disclosure.

FIG. 3A illustrates an example of an augmented reality enhanced application engine, in accordance with aspects of the present disclosure.

FIG. 3B is a block diagram illustrating an example system for hand tracking, in accordance with aspects of the present disclosure.

FIG. 4 is a diagram illustrating an example of landmark points of a hand, in accordance with aspects of the present disclosure.

FIG. 5A is a perspective diagram illustrating an HMD that performs feature tracking and/or visual simultaneous localization and mapping (VSLAM), in accordance with some examples.

FIG. 5B is a perspective diagram illustrating an HMD being worn by a user, in accordance with some examples.

FIG. 6A is a perspective diagram illustrating a front surface of a mobile device that performs feature tracking and/or VSLAM using one or more front-facing cameras, in accordance with some examples.

FIG. 6B is a perspective diagram illustrating a rear surface of a mobile device, in accordance with aspects of the present disclosure.

FIG. 7 is a diagram illustrating an example of a user using a hand gesture to control an operation of a device, in accordance with aspects of the present disclosure.

FIG. 8 is a diagram illustrating examples of different hand gestures that may be used to control operations of a device, in accordance with aspects of the present disclosure.

FIG. 9 is a diagram illustrating examples of different combinations of hand gestures and touch gestures to control different operations of a device, in accordance with aspects of the present disclosure.

FIG. 10 is a table illustrating examples of different operations that correspond to the different combinations of hand gestures and touch gestures of FIG. 9, in accordance with aspects of the present disclosure.

FIG. 11 is a diagram illustrating examples of different hand gestures that each indicate a different number, in accordance with aspects of the present disclosure.

FIG. 12 is a diagram illustrating an example of a process for controlling a device, where no number is detected and a default settings list is invoked, in accordance with aspects of the present disclosure.

FIG. 13 is a diagram illustrating an example of a process for controlling a device, where a number two is detected and an associated second settings list is invoked, in accordance with aspects of the present disclosure.

FIG. 14 is a flow diagram illustrating an example of a process for controlling a device, in accordance with some examples.

FIG. 15 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As previously mentioned, an XR (e.g., virtual reality, augmented reality, mixed reality) system or device may provide a user with a virtual experience (e.g., an XR experience) by immersing the user in a completely virtual environment (made up of virtual content) and/or may provide the user with an augmented or mixed reality experience by combining a real-world or physical environment with a virtual environment. XR systems or devices may include VR systems facilitating interactions with VR environments, AR systems facilitating interactions with AR environments, MR systems facilitating interactions with MR environments, and/or other XR systems. Examples of an XR system or device can include an HMD, such as an AR/VR HMD, which may be in the form of smart glasses. An XR system or device (e.g., an HMD) can be paired or implemented with a touch pad, which can be used by a user to control their XR experiences from the XR system or device.

Currently, many XR devices (e.g., in the form of HMDs) support the use of hand gestures (e.g., hand gesture controls, such as fist closures, directional hand waves, quick hand swipes, pinch movements, etc.) by users for controlling the XR devices. For example, hand gestures may be used by users for controlling various operations of the XR devices, such as for scrolling, capturing, zooming, selecting, and/or controlling volume of the devices. Recognition of the hand gestures may not always be accurate, as some users may perform the hand gestures in a slightly incorrect manner such that the hand gestures are not able to be recognized by the device and, as such, the actions associated with the hand gestures are not enabled by the device to occur.

Many XR devices (e.g., HMDs) have touch pads, which are usually implemented within the left or right side hinges of the devices. These touch pads can be used by users to control the devices. Gesture controls are often employed to assist in controlling these devices because the touch pads alone can only be assigned with minimal functionality. For example, a touch pad alone may only allow for a small number of possible touch gestures (e.g., such as a single tap operation, a double tap operation, a press and hold operation, a swipe forward operation, and/or a swipe back operation), which can only provide the user with a minimal number of control options (e.g., each touch gesture may only be assigned to one control option and, as such, there may be a total of only five possible control options) for controlling the device.

As such, improved systems and techniques that provide many control options to a user to control a device (e.g., an XR device, such as in the form of an HMD device), while allowing for an accurate detection of hand gestures of the user, can be beneficial.

Accordingly, systems, apparatuses, processes (also referred to as methods), and computer-readable media (collectively referred to herein as “systems and techniques”) are described herein that provide a mechanism for controlling a device (e.g., an XR device, such as in the form of an HMD device). In one or more aspects, the systems and techniques combine touch gestures with basic hand gestures to provide users with many control options for controlling a device (e.g., an XR device) in an easier and more efficient manner. The combination of the touch and hand gestures together can be used to define more comprehensive control options for controlling the device, while providing a more accurate recognition of gestures can be more accurate due to the simplicity of the gestures that can be performed.

In some aspects, the systems and techniques combine first hand gestures (e.g., by a first hand) with second hand gestures (e.g., by the first hand or a second hand) to provide users with many control options for controlling a device (e.g., an XR device) in a more easy and efficient manner. The combination of the first hand gestures and the second hand gestures together may be used to define more comprehensive control options for controlling the device.

In one or more aspects, for controlling a device (e.g., an XR device, such as in the form of an HMD), one or more sensors may detect a hand gesture, of a plurality of hand gestures, of a hand of a user. In one or more examples, each sensor of the one or more sensors may be a red, green, blue (RGB) image sensor (e.g., camera) or a monochrome image sensor (e.g., camera). In one or more examples, each sensor of the one or more sensors may be implemented within the device itself or within another device. In some examples, the other device may be a mobile device associated with the user, such as a smart phone or a wearable device. In one or more examples, the other device (e.g., smart phone) may communicate with the device (e.g., XR device) wirelessly (e.g., via Bluetooth) and/or via wire.

In one or more examples, a touch pad may be implemented within the device (e.g., the XR device). In some examples, the touch pad may be implemented within the left or right side hinges of the device. For controlling the device, the touch pad may detect a touch gesture, of a plurality of touch gestures, by the user. In one or more examples, the plurality of touch gestures may include, but is not limited to, a single tap operation, a double tap operation, a press and hold operation, a swipe forward operation, and/or a swipe backward operation. In one or more examples, the detecting of the hand gesture and the detecting of the touch gesture occur simultaneously (e.g., at the same time). For instance, a user may perform a touch gesture with one hand while performing a hand gesture (e.g., holding up a number of fingers) with the user's other hand.

In one or more examples, one or more processors may determine a number associated with the hand gesture. In one or more examples, the hand gesture may be in the form of the user holding up a certain number of fingers (e.g., which can be easily recognizable by the device) with their hand in front of the one or more sensors to indicate a specific number (e.g., which is the same as the number of fingers). In some examples, each processor of the one or more processors may be implemented within the device (e.g., the XR device) or within another device (e.g., a mobile device associated with the user, such as a smart phone or a wearable device).

The one or more processors may determine a settings list, of a plurality of settings lists, based on the determined number associated with the detected hand gesture. In one or more examples, each settings list, of the plurality of settings lists, may be associated with a number. For example, the one or more processors may determine a first settings list (e.g., settings list one of a total of three different settings lists) when the determined number from the hand gesture is one (e.g., the user holding up one finger), may determine a second settings list (e.g., settings list two of the total of three different settings lists) when the determined number from the hand gesture is two (e.g., the user is holding up two fingers), and so on.

In one or more examples, each different settings list, of the plurality of settings lists, may be associated with different control options. In some examples, the control options may include, but is not limited to, a pause operation, a select operation, a next operation, a voice assist operation, a volume up operation, a volume down operation, an increase brightness operation, a decrease brightness operation, a launch camera operation, a zoom in operation, and/or a zoom out operation. In one or more examples, each control option may be associated with a specific touch gesture.

The one or more processors may determine the control option, of the plurality of control options, of the settings list based on the touch gesture. For example, when a hand gesture associated with a number two is used to indicate a second settings list (e.g., settings list two), a touch gesture of a single tap may be used to specifically enable a control option to increase the brightness for the display of the device. The one or more processors may then enable the determined control option (e.g., to increase the brightness of the display) to occur.

In one or more examples, after the one or more processors determine the settings list (e.g., settings list two), of the plurality of settings lists, based on the determined number (e.g., two) associated with the detected hand gesture, the display of the device (e.g., the XR device) may display the determined settings list (e.g., settings list two) to the user. In some examples, the display of the device may display the determined settings list in the form of an overlay image on the display.

In one or more aspects, the systems and techniques increase the user input operations (e.g., control options) of a device (e.g., an XR device) to a larger set of operations by using only a small number of different hand gestures (e.g., using only a total of five different hand gestures). As such, the systems and techniques provide an increased number of efficient control options for users for controlling devices. In one or more examples, a camera from a mobile phone may be employed as a source for input images for the device (e.g., an XR device). The camera may obtain the images, which capture hand gestures of a user for controlling the device. The device may communicate with the mobile phone via a wireless communication protocol (e.g., via Bluetooth), and the device may receive the images from the mobile phone via the wireless communication protocol.

Additional aspects of the present disclosure are described in more detail below.

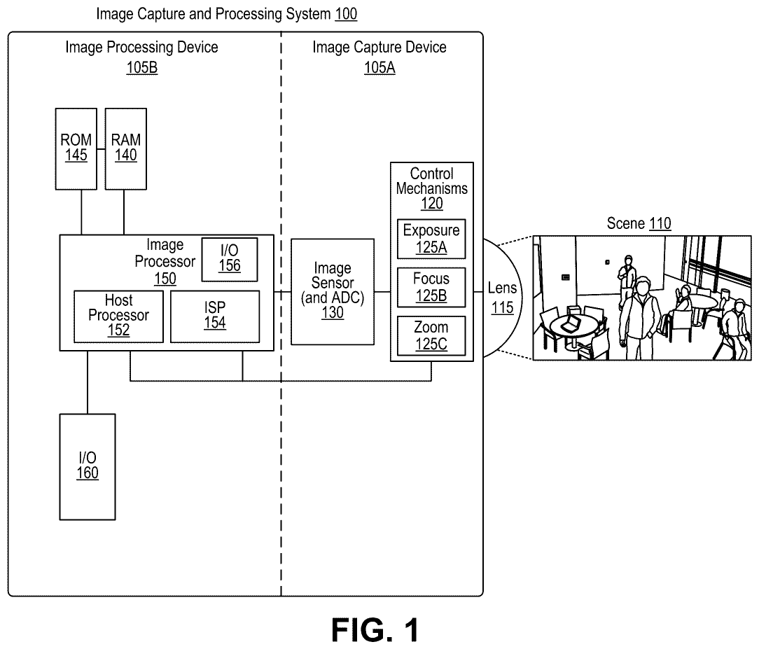

Various aspects of the application will be described with respect to the figures. FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

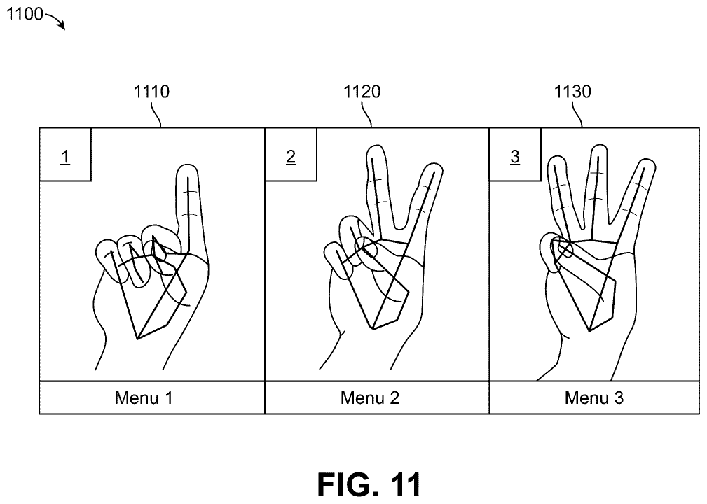

The image processor 150 may include one or more processors, such as one or more image signal processors (ISPs) (including ISP 154), one or more host processors (including host processor 152), and/or one or more of any other type of processor 1110 discussed with respect to the computing system 1100 of FIG. 11. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1025, read-only memory (ROM) 145/1020, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices, any other input devices, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

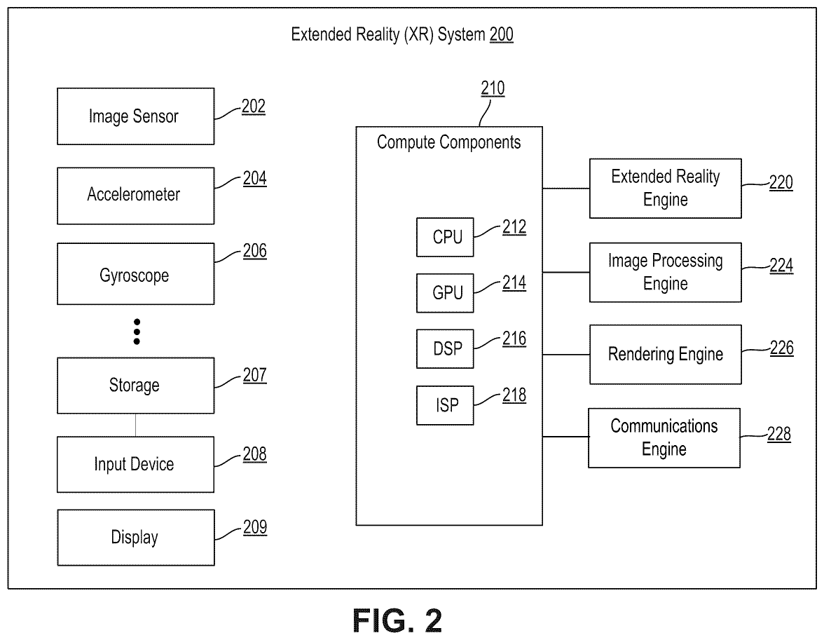

FIG. 2 is a diagram illustrating an architecture of an example extended reality (XR) system 200, in accordance with some aspects of the disclosure. In some examples, the extended reality (XR) system 200 of FIG. 2 can include the image capture and processing system 100, the image capture device 105A, the image processing device 105B, or a combination thereof. The XR system 200 can run (or execute) XR applications and implement XR operations. In some examples, the XR system 200 can perform tracking and localization, mapping of an environment in the physical world (e.g., a scene), and/or positioning and rendering of virtual content on a display 209 (e.g., a screen, visible plane/region, and/or other display) as part of an XR experience. For example, the XR system 200 can generate a map (e.g., a three-dimensional (3D) map) of an environment in the physical world, track a pose (e.g., location and position) of the XR system 200 relative to the environment (e.g., relative to the 3D map of the environment), position and/or anchor virtual content in a specific location(s) on the map of the environment, and render the virtual content on the display 209 such that the virtual content appears to be at a location in the environment corresponding to the specific location on the map of the scene where the virtual content is positioned and/or anchored. The display 209 can include a glass, a screen, a lens, a projector, and/or other display mechanism that allows a user to see the real-world environment and also allows XR content to be overlaid, overlapped, blended with, or otherwise displayed thereon.

In this illustrative example, the XR system 200 includes one or more image sensors 202, an accelerometer 204, a gyroscope 206, storage 207, compute components 210, an XR engine 220, an image processing engine 224, a rendering engine 226, and a communications engine 228. It should be noted that the components 202-228 shown in FIG. 2 are non-limiting examples provided for illustrative and explanation purposes, and other examples can include more, fewer, or different components than those shown in FIG. 2. For example, in some cases, the XR system 200 can include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors. audio sensors, etc.), one or more display devices, one or more other processing engines, one or more other hardware components, and/or one or more other software and/or hardware components that are not shown in FIG. 2. While various components of the XR system 200, such as the image sensor 202, may be referenced in the singular form herein, it should be understood that the XR system 200 may include multiple of any component discussed herein (e.g., multiple image sensors 202).

The XR system 200 includes or is in communication with (wired or wirelessly) an input device 208. The input device 208 can include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, the image sensor 202 can capture images that can be processed for interpreting gesture commands.

The XR system 200 can also communicate with one or more other electronic devices (wired or wirelessly). For example, communications engine 228 can be configured to manage connections and communicate with one or more electronic devices. In some cases, the communications engine 228 can correspond to the communications interface 1140 of FIG. 11.

In some implementations, the one or more image sensors 202, the accelerometer 204, the gyroscope 206, storage 207, compute components 210, XR engine 220, image processing engine 224, and rendering engine 226 can be part of the same computing device. For example, in some cases, the one or more image sensors 202, the accelerometer 204, the gyroscope 206, storage 207, compute components 210, XR engine 220, image processing engine 224, and rendering engine 226 can be integrated into an HMD, extended reality glasses, smartphone, laptop, tablet computer, gaming system, and/or any other computing device. However, in some implementations, the one or more image sensors 202, the accelerometer 204, the gyroscope 206, storage 207, compute components 210, XR engine 220, image processing engine 224, and rendering engine 226 can be part of two or more separate computing devices. For example, in some cases, some of the components 202-226 can be part of, or implemented by, one computing device and the remaining components can be part of, or implemented by, one or more other computing devices.

The storage 207 can be any storage device(s) for storing data. Moreover, the storage 207 can store data from any of the components of the XR system 200. For example, the storage 207 can store data from the image sensor 202 (e.g., image or video data), data from the accelerometer 204 (e.g., measurements), data from the gyroscope 206 (e.g., measurements), data from the compute components 210 (e.g., processing parameters, preferences, virtual content, rendering content, scene maps, tracking and localization data, object detection data, privacy data, XR application data, face recognition data, occlusion data, etc.), data from the XR engine 220, data from the image processing engine 224, and/or data from the rendering engine 226 (e.g., output frames). In some examples, the storage 207 can include a buffer for storing frames for processing by the compute components 210.

The one or more compute components 210 can include a central processing unit (CPU) 212, a graphics processing unit (GPU) 214, a digital signal processor (DSP) 216, an image signal processor (ISP) 218, and/or other processor (e.g., a neural processing unit (NPU) implementing one or more trained neural networks). The compute components 210 can perform various operations such as image enhancement, computer vision, graphics rendering, extended reality operations (e.g., tracking, localization, pose estimation, mapping, content anchoring, content rendering, etc.), image and/or video processing, sensor processing, recognition (e.g., text recognition, facial recognition, object recognition, feature recognition, tracking or pattern recognition, scene recognition, occlusion detection, etc.), trained machine learning operations, filtering, and/or any of the various operations described herein. In some examples, the compute components 210 can implement (e.g., control, operate, etc.) the XR engine 220, the image processing engine 224, and the rendering engine 226. In other examples, the compute components 210 can also implement one or more other processing engines.

The image sensor 202 can include any image and/or video sensors or capturing devices. In some examples, the image sensor 202 can be part of a multiple-camera assembly, such as a dual-camera assembly. The image sensor 202 can capture image and/or video content (e.g., raw image and/or video data), which can then be processed by the compute components 210, the XR engine 220, the image processing engine 224, and/or the rendering engine 226 as described herein. In some examples, the image sensors 202 may include an image capture and processing system 100, an image capture device 105A, an image processing device 105B, or a combination thereof.

In some examples, the image sensor 202 can capture image data and can generate images (also referred to as frames) based on the image data and/or can provide the image data or frames to the XR engine 220, the image processing engine 224, and/or the rendering engine 226 for processing. An image or frame can include a video frame of a video sequence or a still image. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, the image sensor 202 (and/or other camera of the XR system 200) can be configured to also capture depth information. For example, in some implementations, the image sensor 202 (and/or other camera) can include an RGB-depth (RGB-D) camera. In some cases, the XR system 200 can include one or more depth sensors (not shown) that are separate from the image sensor 202 (and/or other camera) and that can capture depth information. For instance, such a depth sensor can obtain depth information independently from the image sensor 202. In some examples, a depth sensor can be physically installed in the same general location as the image sensor 202, but may operate at a different frequency or frame rate from the image sensor 202. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

The XR system 200 can also include other sensors in its one or more sensors. The one or more sensors can include one or more accelerometers (e.g., accelerometer 204), one or more gyroscopes (e.g., gyroscope 206), and/or other sensors. The one or more sensors can provide velocity, orientation, and/or other position-related information to the compute components 210. For example, the accelerometer 204 can detect acceleration by the XR system 200 and can generate acceleration measurements based on the detected acceleration. In some cases, the accelerometer 204 can provide one or more translational vectors (e.g., up/down, left/right, forward/back) that can be used for determining a position or pose of the XR system 200. The gyroscope 206 can detect and measure the orientation and angular velocity of the XR system 200. For example, the gyroscope 206 can be used to measure the pitch, roll, and yaw of the XR system 200. In some cases, the gyroscope 206 can provide one or more rotational vectors (e.g., pitch, yaw, roll). In some examples, the image sensor 202 and/or the XR engine 220 can use measurements obtained by the accelerometer 204 (e.g., one or more translational vectors) and/or the gyroscope 206 (e.g., one or more rotational vectors) to calculate the pose of the XR system 200. As previously noted, in other examples, the XR system 200 can also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors can include at least one IMU. An IMU is an electronic device that measures the specific force, angular rate, and/or the orientation of the XR system 200, using a combination of one or more accelerometers, one or more gyroscopes, and/or one or more magnetometers. In some examples, the one or more sensors can output measured information associated with the capture of an image captured by the image sensor 202 (and/or other camera of the XR system 200) and/or depth information obtained using one or more depth sensors of the XR system 200.

The output of one or more sensors (e.g., the accelerometer 204, the gyroscope 206, one or more IMUs, and/or other sensors) can be used by the XR engine 220 to determine a pose of the XR system 200 (also referred to as the head pose) and/or the pose of the image sensor 202 (or other camera of the XR system 200). In some cases, the pose of the XR system 200 and the pose of the image sensor 202 (or other camera) can be the same. The pose of image sensor 202 refers to the position and orientation of the image sensor 202 relative to a frame of reference (e.g., with respect to the scene 110). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees Of Freedom (3DoF), which refers to the three angular components (e.g. roll, pitch, and yaw).

In some cases, a device tracker (not shown) can use the measurements from the one or more sensors and image data from the image sensor 202 to track a pose (e.g., a 6DoF pose) of the XR system 200. For example, the device tracker can fuse visual data (e.g., using a visual tracking solution) from the image data with inertial data from the measurements to determine a position and motion of the XR system 200 relative to the physical world (e.g., the scene) and a map of the physical world. As described below, in some examples, when tracking the pose of the XR system 200, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of the XR system 200 within the scene and the 3D map of the scene, etc. The 3D map can provide a digital representation of a scene in the real/physical world. In some examples, the 3D map can anchor location-based objects and/or content to real-world coordinates and/or objects. The XR system 200 can use a mapped scene (e.g., a scene in the physical world represented by, and/or associated with, a 3D map) to merge the physical and virtual worlds and/or merge virtual content or objects with the physical environment.

In some aspects, the pose of image sensor 202 and/or the XR system 200 as a whole can be determined and/or tracked by the compute components 210 using a visual tracking solution based on images captured by the image sensor 202 (and/or other camera of the XR system 200). For instance, in some examples, the compute components 210 can perform tracking using computer vision-based tracking, model-based tracking, and/or simultaneous localization and mapping (SLAM) techniques. For instance, the compute components 210 can perform SLAM or can be in communication (wired or wireless) with a SLAM system (not shown). SLAM refers to a class of techniques where a map of an environment (e.g., a map of an environment being modeled by XR system 200) is created while simultaneously tracking the pose of a camera (e.g., image sensor 202) and/or the XR system 200 relative to that map. The map can be referred to as a SLAM map, and can be three-dimensional (3D). The SLAM techniques can be performed using color or grayscale image data captured by the image sensor 202 (and/or other camera of the XR system 200), and can be used to generate estimates of 6DoF pose measurements of the image sensor 202 and/or the XR system 200. Such a SLAM technique configured to perform 6DoF tracking can be referred to as 6DoF SLAM. In some cases, the output of the one or more sensors (e.g., the accelerometer 204, the gyroscope 206, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 202 (and/or other camera) to the SLAM map. For example, 6DoF SLAM can use feature point associations from an input image to determine the pose (position and orientation) of the image sensor 202 and/or XR system 200 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 202 and/or the XR system 200 can be determined by projecting features from the 3D SLAM map into an image or video frame and updating the camera pose from verified 2D-3D correspondences.

In one illustrative example, the compute components 210 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

In some cases, the XR system 200 can also track the hand and/or fingers of the user to allow the user to interact with and/or control virtual content in a virtual environment. For example, the XR system 200 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

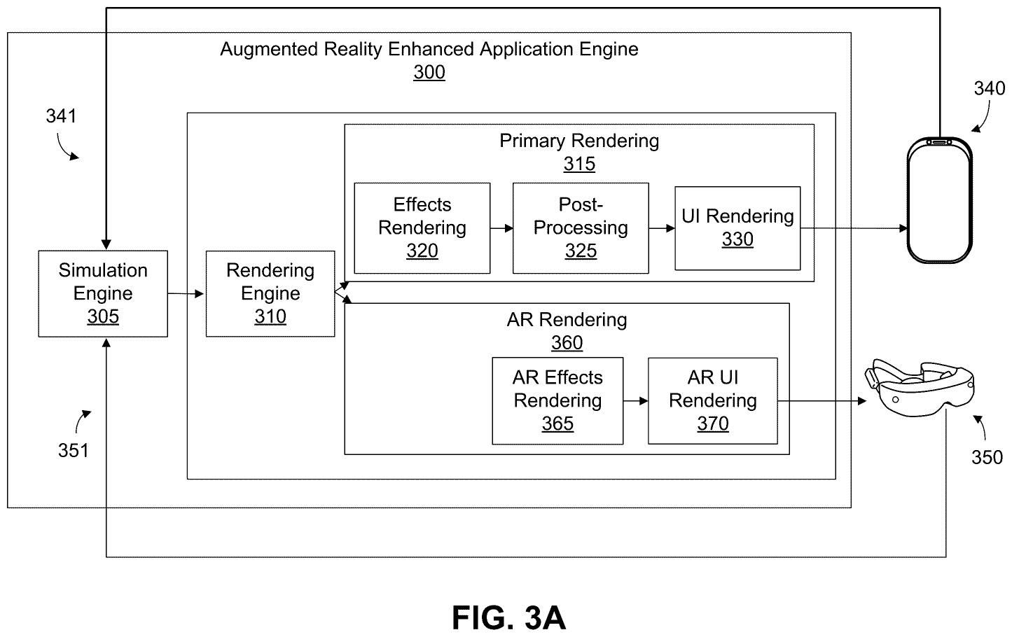

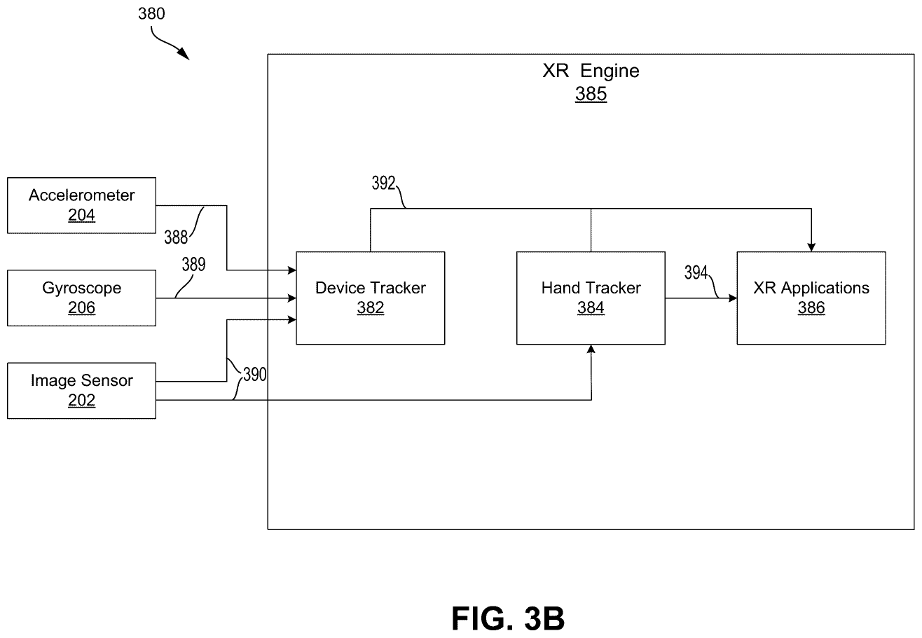

FIG. 3A illustrates an example of an augmented reality enhanced application engine 300, in accordance with aspects of the present disclosure. In some cases, the augmented reality enhanced application engine 300 may be implemented as a part of the XR engine 220 of FIG. 2. In the illustrative example, the augmented reality enhanced application engine 300 includes a simulation engine 305, a rendering engine 310, a primary rendering module 315, and AR rendering module 360. As illustrated, the primary rendering module 315 can include an effects rendering engine 320, a post-processing engine 325, and a user interface (UI) rendering engine 330. The AR rendering module 360 can include an AR effects rendering engine 365 and an AR UI rendering engine 370. It should be noted that the components 305-370 shown in FIG. 3A are non-limiting examples provided for illustrative and explanation purposes, and other examples can include more, fewer, or different components than those shown in FIG. 3A.

In some cases, the augmented reality enhanced application engine 300 is included in and/or is in communication with (wired or wirelessly) an electronic device 340. In some examples, the augmented reality enhanced application engine 300 is included in and/or is in communication with (wired or wirelessly) an XR system 350.

In the illustrated example of FIG. 3A, the simulation engine 305 can generate a simulation for the augmented reality enhanced application engine 300. In some cases, the simulation can include, for example, one or more images, one or more videos, one or more strings of characters (e.g., alphanumeric characters, numbers, text, Unicode characters, symbols, and/or icons), one or more two-dimensional (2D) shapes (e.g., circles, ellipses, squares, rectangles, triangles, other polygons, rounded polygons with one or more rounded corners, portions thereof, or combinations thereof), one or more three-dimensional (3D) shapes (e.g., spheres, cylinders, cubes, pyramids, triangular prisms, rectangular prisms, tetrahedrons, other polyhedrons, rounded polyhedrons with one or more rounded edges and/or corners, portions thereof, or combinations thereof), textures for shapes, bump-mapping for shapes, lighting effects, or combinations thereof. In some examples, the simulation can include at least a portion of an environment. The environment may be a real-world environment, a virtual environment, and/or a mixed environment that includes real-world environment elements and virtual environment elements.

In some cases, the simulation generated by the simulation engine 305 can be dynamic. For example, the simulation engine 305 can update the simulation based on different triggers, including, without limitation, physical contact, sounds, gestures, input signals, passage of time, and/or any combination thereof. As used herein, an application state of the augmented reality enhanced application engine 300 can include any information associated with the simulation engine 305, rendering engine 310, primary rendering module 315, effects rendering engine 320, post-processing engine 325, UI rendering engine 330, AR rendering module 360, AR effects rendering engine 365, AR UI rendering engine 370, inputs to the augmented reality enhanced application engine 300, outputs from the augmented reality enhanced application engine 300, and/or any combination thereof at a particular moment in time.

As illustrated, the simulation engine 305 can obtain mobile device input 341 from the mobile device 340. In some cases, the simulation engine 305 can obtain XR system input 351 from the XR system 350. The mobile device input 341 and/or XR system input 351 can include, for example, user input through a user interface of the application displayed on the display of the mobile device 340, user inputs from an input device (e.g., input device 208 of FIG. 2), one or more sensors (e.g., image sensor 202, accelerometer 204, gyroscope 206 of FIG. 2). In some cases, simulation engine 305 can update the application state for the augmented reality enhanced application engine 300 based on the mobile device input 341, XR system input 351, and/or any combination thereof.

In the illustrative example of FIG. 3A, the rendering engine 310 can obtain application state information from the simulation engine 305. In some cases, the rendering engine 310 can determine portions of the application state information to be rendered by the displays available to the augmented reality enhanced application engine 300. For example, the rendering engine rendering engine 310 can determine whether a connection (wired or wireless) has been established between the XR system 350 and the mobile device 340. In some cases, the rendering engine 310 can determine the application state information to be rendered by the primary rendering module 315 and the AR rendering module 360. In some cases, the rendering engine 310 can determine that the XR system 350 is not connected (wired or wirelessly) to the mobile device 340. In some cases, the rendering engine 310 can determine the application state information for the primary rendering module 315 and forego determining application state information to be rendered by the AR rendering module 360 that will not be displayed. Accordingly, the rendering engine 310 can facilitate an adaptive rendering configuration for the augmented reality enhanced application engine 300 based on the availability and/or types of available displays. In some implementations, a separate rendering engine 310 as shown in FIG. 3A may be excluded. In one illustrative example, the primary rendering module 315 and/or AR rendering module 360 can include at least a portion of the functionality of the rendering engine 310 described above.

The primary rendering module 315 can include an effects rendering engine 320, post-processing engine 325, and UI rendering engine 330. In some cases, the primary rendering module 315 can render image frames configured for display on a display of the mobile device 340. As illustrated, the primary rendering module 315 can output the generated image frames (e.g., media content) to be displayed on a display of the mobile device 340. In some cases, effects rendering information can be used to render application state information generated by the simulation engine 305. For example, the effects rendering engine can generate a 2D projection of a portion of a 3D environment included in the application state information. For example, the effects rendering engine 320 may generate a perspective projection of the 3D environment by a virtual camera. In some cases, the application state information can include a pose of the virtual camera within the environment. In some cases, the effects rendering engine 320 can generate additional visual effects that are not included within the 3D environment. For example, the effects rendering engine 320 can apply texture maps to enhance the visual appearance of the effects generated by the effects rendering engine 320. In some cases, the effects rendering engine 320 can exclude portions of the application state information designated for the AR rendering module 360 by the rendering engine 310. For example, the primary rendering module 315 may exclude effects present in the environment of the simulation.

In some cases, post-processing engine 325 can provide additional processing to the rendered effects generated by the effects rendering engine 320. For example, the post-processing engine 325 can perform scaling, image smoothing, z-buffering, contrast enhancement, gamma, color mapping, any other image processing, and/or any combination thereof.

In some implementations, UI rendering engine 330 can render a UI. In some cases, the user interface can provide application state information in addition to the effects rendered based on the application environment (e.g., a 3D environment). In some cases, the UI can be generated as an overlay over a portion of the image frame output by the post-processing engine 325.

The AR rendering module 360 can include an AR effects rendering engine 365, an AR UI rendering engine 370. In some cases, the AR effects rendering engine 365 can render application state information generated by the simulation engine 305. For example, the AR effects rendering engine 365 can generate a 2D projection of a 3D environment included in the application state information. In some cases, the AR effects rendering engine 365 can generate effects that appear to protrude out from the display surface of the display of the mobile device 340.

In some cases, the display of the XR system 350 can have different display parameters (e.g., a different resolution, frame rate, aspect ratio, and/or any other display parameters) than the display of the mobile device 340. In some cases, the display parameters can also vary between different types of output devices (e.g., different HMD models, other XR systems, or the like). As a result, rendering display data for the 350 with the AR rendering module 360 can affect performance of the primary rendering module 315 (e.g., by consuming computational resources of a GPU, CPU, memory, or the like). In some cases, inclusion of the AR rendering module 360 within the augmented reality enhanced application engine 300 can require periodic updates to provide compatibility with different devices.

As indicated above, in some cases, an XR system may track physical objects, such as parts of the user, to allow the user to interact with virtual content, such as virtual objects. As an example, the XR system may use one or more cameras (e.g., image sensor 130 of FIG. 1, image sensor 202 of FIG. 2, and the like) to track a hand of the user via one or more landmarks of the hands (e.g., physical object).

FIG. 3B is a block diagram illustrating an example system for hand tracking 380, in accordance with aspects of the present disclosure. In FIG. 3B, a device tracker 382 can receive measurements 388 from an accelerometer 204, measurements 389 from a gyroscope 206, and image data 390 from image sensor 202 (e.g., image sensor 202 of FIG. 2). In some examples, the measurements 388 may include motion measurements from the accelerometer 204 (e.g., accelerometer 204 of FIG. 2) and the measurements 389 may include orientation measurements from the gyroscope 206 (e.g., gyroscope 206 of FIG. 2). For example, the measurements 388 can include one or more translational vectors (e.g., up/down, left/right, forward/back) from the accelerometer 204 and the measurements 388 can include one or more rotational vectors (e.g., pitch, yaw, roll) from the gyroscope 206. Moreover, the image data 390 can include one or more images or frames captured by the image sensor 202 (e.g., image sensor 202 of FIG. 2). The one or more images or frames can capture a scene associated with the XR system and/or one or more portions of the scene (e.g., one or more regions, objects, humans, etc.).

In some examples, the device tracker 382 may be implemented as a part of an XR engine 385 (e.g., XR engine 220 of FIG. 2) of an extended reality system. In other cases, the device tracker 382 can be separate from the XR engine 385 and implemented by one or more of the compute components on the XR system.

The device tracker 382 may use the measurements 388, 389 and image data 390 to track a pose (e.g., a 6DOF pose) of the extended reality system. For example, the device tracker 382 may fuse visual data from the image data 390 with inertial data (e.g., motion data, orientation data, etc.) from the measurements 388, 389 to determine a position and motion of the extended reality system relative to the physical world (e.g., the scene) and a map of the physical world. In some examples, when tracking the pose of the extended reality system, the device tracker 382 can generate a three-dimensional (3D) map of the scene (e.g., the real world) and/or generate updates for a 3D map of the scene. The 3D map updates can include, for example and without limitation, new or updated features and/or landmark points associated with the scene and/or the 3D map of the scene, localization updates identifying or updating a position of the extended reality system within the scene and the 3D map of the scene, etc. The 3D map can provide a digital representation of a scene in the real/physical world. In some examples, the 3D map can anchor location-based objects and/or content to real-world coordinates and/or objects. The extended reality system can use a mapped scene (e.g., a scene in the physical world represented by, and/or associated with, a 3D map) to merge the physical and virtual worlds and/or merge virtual content or objects with the physical environment.

The device tracker 382 may provide tracking data 392 generated from the measurements 388 and the image data 390 to a hand tracker 384, and a set of XR applications 386. The tracking data 392 may include the pose of the XR system and map data calculated by the device tracker 382. The map data can include a 3D map of the scene and/or map updates for a 3D map of the scene, as previously described.

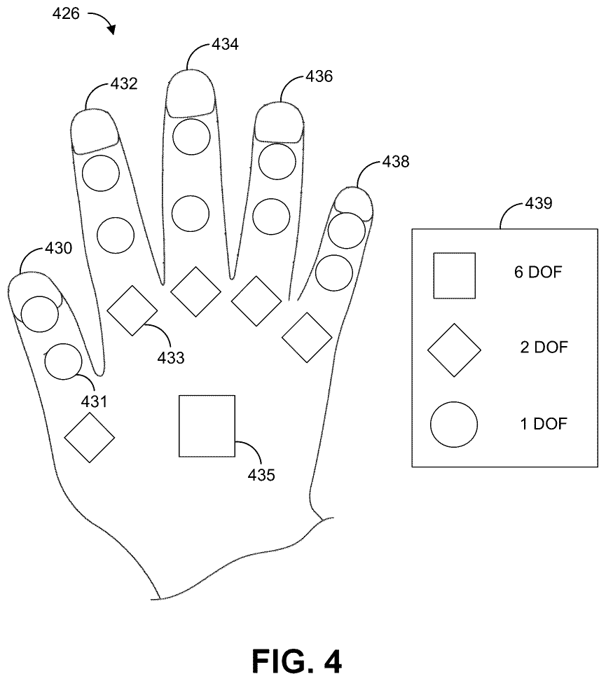

In some cases, the hand tracker 384 may be included as a component of the XR engine 385. In some cases, the hand tracker 384 may be implemented by an XR system to track a hand (e.g., hand 426 of FIG. 4) of the user associated with the XR system and/or fingertips in the hand of the user, as previously explained. For simplicity and explanation purposes, the hand tracker 384 will be described herein as a component for tracking hands. However, it should be noted that, in other examples, the hand tracker 384 may track other objects and/or body parts. For example, as previously noted, the hand tracker 384 may track fingers or fingertips on a hand either in addition to, or instead of, tracking the hand itself.

In some examples, the hand tracker 384 can be part of, or implemented by, the XR engine 385 on the XR system. In other examples, the device tracker 384 may be separate from the XR engine 385 and implemented by one or more of the compute components on the XR system.

The hand tracker 384 may also receive the image data 390 from the image sensor 202. The hand tracker 384 may use the image data 390 and the tracking data 392 to track a hand pose 394 (e.g., a pose of the hand and/or fingers/fingertips of the hand). In some examples, the hand tracker 384 can determine the hand pose 394 based on landmark points of the hand. The hand tracker 384 can then provide the hand pose 394 to one or more XR application 386. In some examples, the XR applications 386 can be an application on the XR system designed and/or configured to provide a particular XR experience. In some cases, an AR engine, such as the augmented reality enhanced application engine 300, may be an XR application 386. The XR applications 386 may also include higher level applications, such, for example, an AR gaming experience, an AR classroom experience, and/or any other XR experiences. The XR applications 386 may be a part of, or implemented by, the XR engine 385 or can be separate from the XR engine 385.

FIG. 4 is a diagram illustrating an example of landmark points of a hand 426, in accordance with aspects of the present disclosure. The landmark points shown in FIG. 4 correspond to different parts of the hand 426, including a landmark point 435 on the palm of the hand, three landmark points on the thumb 430 of the hand 426, three landmark points on the index finger 432 of the hand 426, three landmark points on the middle finger 434 of the hand 426, three landmark points on the ring finger 436 of the hand 426, and three landmark points on the pinky 438 of the hand 426. The palm of the hand 426 can move in three translational directions (e.g., measured in X, Y, and Z directions relative to a plane, such as an image plane) and in three rotational directions (e.g., measured in yaw, pitch, and roll relative to the plane), and thus provides six degrees of freedom (6DOF) that can be used for registration and/or tracking. The 6DOF movement of the palm is illustrated as a square in FIG. 4, as indicated in the legend 439.

The different joints of the fingers of the hand 426 allow for different degrees of movement, as illustrated in the legend 439. As illustrated by the diamond shapes (e.g., diamond 433) in FIG. 4, the base of each finger (corresponding to the metacarpophalangeal joint (MCP) between the proximal phalanx and the metacarpal) has two degrees of freedom (2DOF) corresponding to flexion and extension as well as abduction and adduction. As illustrated by the circle shapes (e.g., circle 431) in FIG. 4, each of the upper joints of each finger (corresponding to the interphalangeal joints between the distal, middle, and proximal phalanges) has one degree of freedom (1DOF) corresponding to flexion and extension.

In some cases, the XR system may use one or more of the landmark points on the hand 426 to track the hand 426 (e.g., track a pose and/or movement of the hand 426) and track interactions with a virtual interface rendered by the XR system. As noted above, as a result of the detection of the one or more landmark points on the hand 426, the pose of the landmark points (and thus the hand and fingers) in relative physical position with respect to the XR system can be established. For example, the landmark points on the palms of the hand 426 (e.g., the landmark point 435) can be detected in an image, and the locations of the landmark points can be determined with respect to an image sensor of the XR system. A point of a virtual interface (e.g., a center point, such as a center of mass or other center point) rendered by the XR system and/or an interface element on the virtual interface selected by the hand 426, or with which the hand 426 has interacted, can be translated to a position on a display (or a rendering on the display) of the XR system relative to the locations determined for the landmark points on the palms of the hand 426. In some examples, a point of a portion of the virtual interface with which the hand 426 has interacted with can be registered relative to locations of one or more landmark points on the hand 426.

In some examples, the XR system can also register the virtual interface and/or the hand 426 to points in the real world (as detected in one or more images) and/or to other parts of the user. For instance, in some implementations, in addition to determining a physical pose of the hand 426 with respect to the XR system and/or a virtual interface, the XR system can determine the location of other landmarks, such as distinctive points (referred to as key points) on walls, one or more corners of objects, features on a floor, points on a human face, points on nearby devices, among others. In some cases, the XR system can place the virtual interface within a certain position with respect to key points detected in the environment, which can correspond to, for example, detected objects and/or humans in the environment.

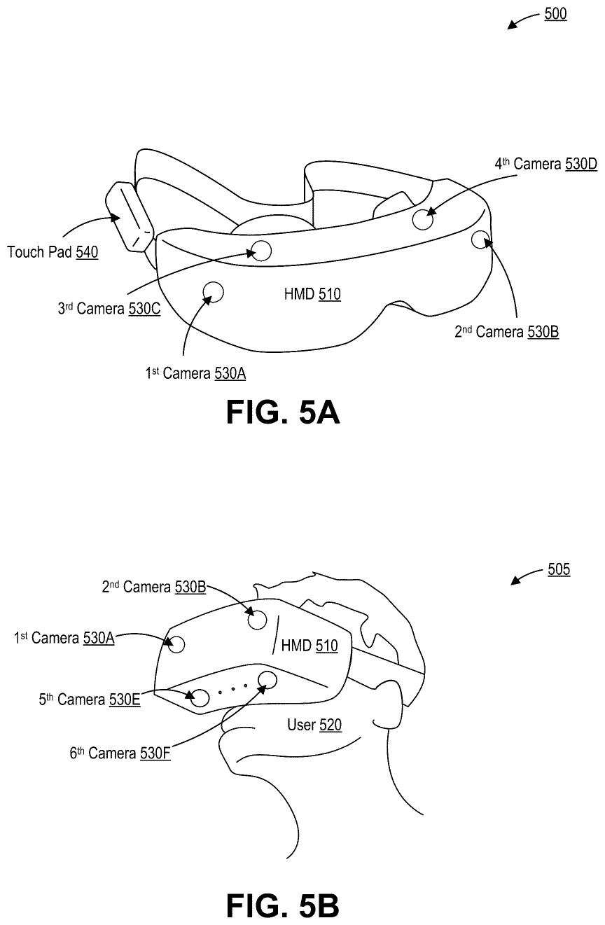

FIG. 5A is a perspective diagram 500 illustrating a head-mounted display (HMD) 510 that performs feature tracking and/or visual simultaneous localization and mapping (VSLAM), in accordance with some examples. The HMD 510 may be, for example, an augmented reality (AR) headset, a virtual reality (VR) headset, a mixed reality (MR) headset, an extended reality (XR) headset, or some combination thereof. The HMD 510 may be an example of an XR system 200. The HMD 510 includes a first camera 530A and a second camera 530B along a front portion of the HMD 510. In some cases, the HMD 510 may also include a third camera 530C, fourth camera 530D, fifth camera (not visible), and sixth camera (not visible). In some examples, the HMD 510 may only have a single camera. In some examples, the HMD 510 may include one or more additional cameras in addition to the first camera 530A and the second camera 530B. In some examples, the HMD 510 may include one or more additional sensors in addition to the first camera 530A and the second camera 530B.

The HMD 510 (e.g., XR device) includes a touch pad 540. In FIG. 5A, the touch pad 540 is shown to be mounted onto the right side of the HMD 510. In one or more examples, the touch pad 540 may be mounted onto the left side of the HMD 510. In some examples, the HMD 510 may include more touch pads (e.g., which may be mounted onto the right and/or left sides of the HMD 510) than the one touch pad 540 as shown in FIG. 5A.

In one or more examples, a user 520 may use touch gestures to control operations (e.g., to perform control options) of the HMD 510 (e.g., XR device). The user 520 may perform a touch gesture by touching the touch pad 540 with a hand (e.g., via one or more fingers of the hand) of the user 520. In one or more examples, the touch gestures may include, but are not limited to, a single tap operation (e.g., where the user 520 taps the touch pad 540 with a single finger once), a double tap operation (e.g., where the user 520 taps the touch pad 540 with a single finger twice), a press and hold operation (e.g., where the user 520 touches the touch pad 540 and holds the touch to the touch pad 540 for a duration of time with a single finger), a swipe forward operation (e.g., where the user 520 swipes the touch pad, with a single finger, in a forward direction, from the back of the head of the user towards the face of the user), and/or a swipe backward operation (e.g., where the user 520 swipes the touch pad, with a single finger, in a backward direction, from the face of the user towards the back of the head of the user). In one or more examples, the control options (e.g., operations) may include, but are not limited to, a pause operation (e.g., to pause a video and/or audio being played by the HMD 510), a select operation (e.g., to select an option being presented by the HMD 510 to the user 520), a next operation (e.g., to move to another screen or another object being presented by the HMD 510 to the user 520), a voice assist operation (e.g., to invoke voice assistance by the HMD 510 for the user 520), a volume up operation (e.g., to increase the volume in audio controlled by the HMD 510), and/or a volume down operation (e.g., to decrease the volume in the audio controlled by the HMD 510).

FIG. 5B is a perspective diagram 530 illustrating the head-mounted display (HMD) 510 of FIG. 5A being worn by a user 520, in accordance with some examples. The user 520 wears the HMD 510 on the user 520's head over the user 520's eyes. The HMD 510 can capture images with the first camera 530A and the second camera 530B. In some examples, the HMD 510 displays one or more display images toward the user 520's eyes that are based on the images captured by the first camera 530A and the second camera 530B. The display images may provide a stereoscopic view of the environment, in some cases with information overlaid and/or with other modifications. For example, the HMD 510 can display a first display image to the user 520's right eye, the first display image based on an image captured by the first camera 530A. The HMD 510 can display a second display image to the user 520's left eye, the second display image based on an image captured by the second camera 530B. For instance, the HMD 510 may provide overlaid information in the display images overlaid over the images captured by the first camera 530A and the second camera 530B. As indicated above, the HMD 510 may also include a fifth camera 530E and sixth camera 530F. In some cases, the third camera 530C, fourth camera 530D, fifth camera 530E and sixth camera 530F may be used primarily for tracking and mapping and images captured by these cameras may not typically be displayed to the user 520.

The HMD 510 includes no wheels, propellers or other conveyance of its own. Instead, the HMD 510 relies on the movements of the user 520 to move the HMD 510 about the environment. Thus, in some cases, the HMD 510, when performing a SLAM technique, can skip path planning using a path planning engine and/or movement actuation using the movement actuator. In some cases, the HMD 510 can still perform path planning using a path planning engine, and can indicate directions to follow a suggested path to the user 520 to direct the user along the suggested path planned using the path planning engine. In some cases, for instance where the HMD 510 is a VR headset, the environment may be entirely or partially virtual. If the environment is at least partially virtual, then movement through the virtual environment may be virtual as well. For instance, movement through the virtual environment can be controlled by an input device 508. The movement actuator may include any such input device 508. Movement through the virtual environment may not require wheels, propellers, legs, or any other form of conveyance. If the environment is a virtual environment, then the HMD 510 can still perform path planning using the path planning engine and/or movement actuation. If the environment is a virtual environment, the HMD 510 can perform movement actuation using the movement actuator by performing a virtual movement within the virtual environment. Even if an environment is virtual, SLAM techniques may still be valuable, as the virtual environment can be unmapped and/or may have been generated by a device other than the HMD 510, such as a remote server or console associated with a video game or video game platform. In some cases, feature tracking and/or SLAM may be performed in a virtual environment even by vehicle or other device that has its own physical conveyance system that allows it to physically move about a physical environment. For example, SLAM may be performed in a virtual environment to test whether a SLAM system is working properly without wasting time or energy on movement and without wearing out a physical conveyance system.

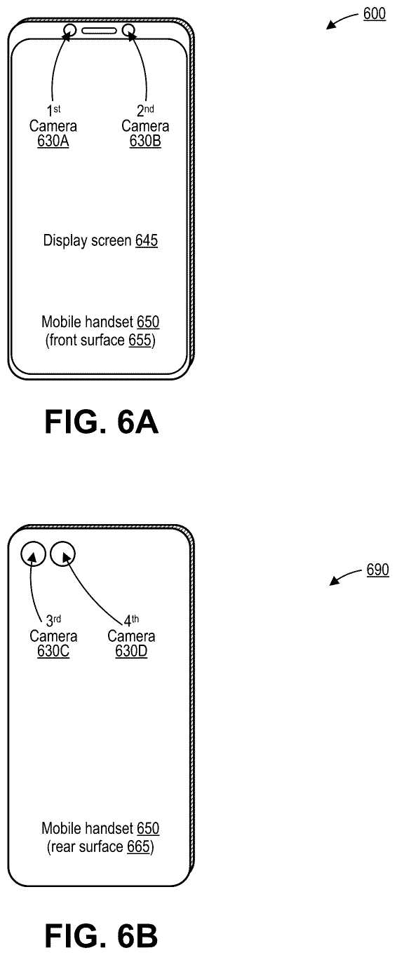

FIG. 6A is a perspective diagram 600 illustrating a front surface 655 of a mobile device 650 that performs feature tracking and/or visual simultaneous localization and mapping (VSLAM) using one or more front-facing cameras 630A-B, in accordance with some examples. The mobile device 650 may be, for example, a cellular telephone, a satellite phone, a portable gaming console, a music player, a health tracking device, a wearable device, a wireless communication device, a laptop, a mobile device, any other type of computing device or computing system 1500 discussed herein, or a combination thereof. The front surface 655 of the mobile device 650 includes a display screen 645. The front surface 655 of the mobile device 650 includes a first camera 630A and a second camera 630B. The first camera 630A and the second camera 630B are illustrated in a bezel around the display screen 645 on the front surface 655 of the mobile device 650. In some examples, the first camera 630A and the second camera 630B can be positioned in a notch or cutout that is cut out from the display screen 645 on the front surface 655 of the mobile device 650. In some examples, the first camera 630A and the second camera 630B can be under-display cameras that are positioned between the display screen 645 and the rest of the mobile device 650, so that light passes through a portion of the display screen 645 before reaching the first camera 630A and the second camera 630B. The first camera 630A and the second camera 630B of the perspective diagram 600 are front-facing cameras. The first camera 630A and the second camera 630B face a direction perpendicular to a planar surface of the front surface 655 of the mobile device 650. In some examples, the front surface 655 of the mobile device 650 may only have a single camera. In some examples, the mobile device 650 may include one or more additional cameras in addition to the first camera 630A and the second camera 630B. In some examples, the mobile device 650 may include one or more additional sensors in addition to the first camera 630A and the second camera 630B.

FIG. 6B is a perspective diagram 690 illustrating a rear surface 665 of a mobile device 650. The mobile device 650 includes a third camera 630C and a fourth camera 630D on the rear surface 665 of the mobile device 650. The third camera 630C and the fourth camera 630D of the perspective diagram 690 are rear-facing. The third camera 630C and the fourth camera 630D face a direction perpendicular to a planar surface of the rear surface 665 of the mobile device 650. While the rear surface 665 of the mobile device 650 does not have a display screen 645 as illustrated in the perspective diagram 690, in some examples, the rear surface 665 of the mobile device 650 may have a second display screen. If the rear surface 665 of the mobile device 650 has a display screen 645, any positioning of the third camera 630C and the fourth camera 630D relative to the display screen 645 may be used as discussed with respect to the first camera 630A and the second camera 630B at the front surface 655 of the mobile device 650. In some examples, the rear surface 665 of the mobile device 650 may only have a single camera. In some examples, the mobile device 650 may include one or more additional cameras in addition to the first camera 630A, the second camera 630B, the third camera 630C, and the fourth camera 630D. In some examples, the mobile device 650 may include one or more additional sensors in addition to the first camera 630A, the second camera 630B, the third camera 630C, and the fourth camera 630D.

Like the HMD 610, the mobile device 650 includes no wheels, propellers, or other conveyance of its own. Instead, the mobile device 650 relies on the movements of a user holding or wearing the mobile device 650 to move the mobile device 650 about the environment. Thus, in some cases, the mobile device 650, when performing a SLAM technique, can skip path planning using the path planning engine and/or movement actuation using the movement actuator. In some cases, the mobile device 650 can still perform path planning using the path planning engine, and can indicate directions to follow a suggested path to the user to direct the user along the suggested path planned using the path planning engine. In some cases, for instance where the mobile device 650 is used for AR, VR, MR, or XR, the environment may be entirely or partially virtual. In some cases, the mobile device 650 may be slotted into a head-mounted device (HMD) (e.g., into a cradle of the HMD) so that the mobile device 650 functions as a display of the HMD, with the display screen 645 of the mobile device 650 functioning as the display of the HMD. If the environment is at least partially virtual, then movement through the virtual environment may be virtual as well. For instance, movement through the virtual environment can be controlled by one or more joysticks, buttons, video game controllers, mice, keyboards, trackpads, and/or other input devices that are coupled in a wired or wireless fashion to the mobile device 650. The movement actuator may include any such input device. Movement through the virtual environment may not require wheels, propellers, legs, or any other form of conveyance. If the environment is a virtual environment, then the mobile device 650 can still perform path planning using the path planning engine and/or movement actuation. If the environment is a virtual environment, the mobile device 650 can perform movement actuation using the movement actuator by performing a virtual movement within the virtual environment.

As previously mentioned, many XR devices (e.g., in the form of HMDs, such as HMD 510 of FIGS. 5A and 5B) currently support the use of hand gestures (e.g., hand gesture controls, such as fist closures, directional hand waves, quick hand swipes, pinch movements, etc.) by users for controlling the XR devices. For example, hand gestures can be used by users for controlling various operations of the XR devices, such as for scrolling, capturing, zooming, selecting, and/or controlling volume of the devices. Recognition of the hand gestures may not always be accurate, as some users may perform the hand gestures in a slightly incorrect manner such that the hand gestures are not able to be recognized by the device. As such, the actions associated with the hand gestures are not enabled by the device to occur.

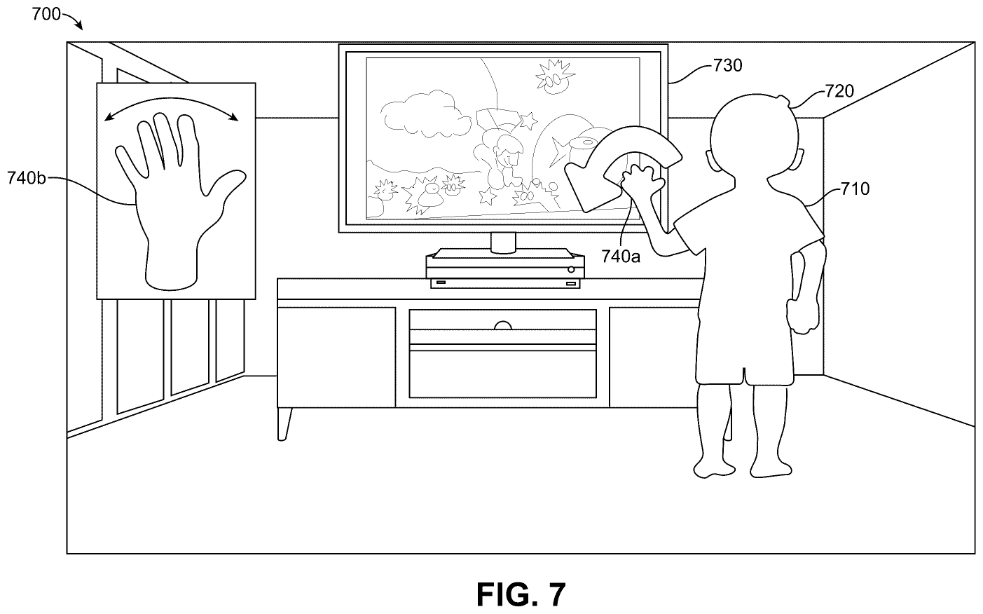

FIG. 7 is a diagram illustrating an example of a user 710 using a hand gesture 740a to control an operation of a device 720 (e.g., an XR device). In FIG. 7A, the user 710 is shown to be wearing the device 720, which is the form of an HMD (e.g., HMD 510 of FIGS. 5A and 5B). The user 710 is within a room 700 with a screen 730 displaying an XR scene that is being controlled by the device 720. The user 710 is using a hand gesture 740a (e.g., shown in more detail as hand gesture 740b) to enable a control option (e.g., control operation) of the device 720 for controlling an aspect of the XR experience being displayed on the screen 730. In FIG. 7, the hand gesture 740a, 740b is shown to be a hand waving gesture (e.g., a waving of the hand of the user 710 from side to side).

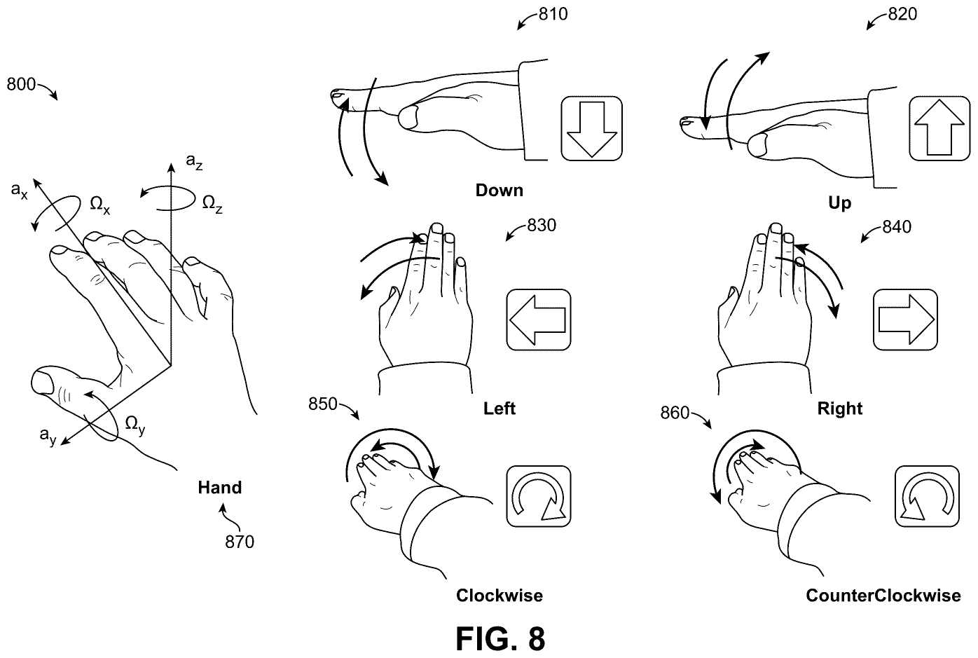

FIG. 8 is a diagram illustrating examples of different hand gestures 800 that may be used by a user to enable different control options (e.g., control operations) of a device. In FIG. 8, a hand 870 of a user (e.g., user 710 of FIG. 7) is shown to have multiple axes, which include an ax axis, an ay axis, and an a_{z} axis. These different axes can be used to determine the different hand gestures made by the hand 870. In FIG. 8, the different hand gestures 800 include a down hand gesture 810 (e.g., a waving of the hand 870 in a downward direction), an up hand gesture 820 (e.g., a waving of the hand 870 in an upward direction), a left hand gesture 830 (e.g., a waving of the hand 870 in a left direction), a right hand gesture 840 (e.g., a waving of the hand 870 in a right direction), a clockwise hand gesture 850 (e.g., a waving of the hand 870 in a clockwise direction), and a counter-clockwise hand gesture 860 (e.g., a waving of the hand 870 in a counter-clockwise direction). In one or more examples, hand gestures in addition to and/or other than the different hand gestures 800 shown in FIG. 8 may be employed. For example, these hand gestures may include, but are not limited to, a gesture of one or more fingers indicating a number (e.g., presenting one or more fingers of the hand 870 to indicate a number corresponding to the number of fingers being presented), a fist gesture (e.g., the hand 870 being closed in a fist), a hand waving gesture (e.g., a waving of the hand 870 from side to side, such as hand wave gesture 740a, 740b), a pinching gesture (e.g., pinching fingers of the hand 870 together), and/or a hand movement gesture to form a shape (e.g., a waving of the hand to form a shape, such as a circle, square, or triangle).

Many XR devices (e.g., HMDs) have touch pads (e.g., touch pad 540 of FIG. 5A). These touch pads are usually implemented within the left or right side hinges of the devices. These touch pads may be used by users to control the devices. Gesture controls are often utilized to assist users in controlling these devices because the touch pads alone may only be assigned with minimal functionality. For example, a touch pad alone may only allow for a small number of possible touch gestures (e.g., such as a single tap operation, a double tap operation, a press and hold operation, a swipe forward operation, and/or a swipe back operation), which may only provide the user with a minimal number of control options (e.g., each touch gesture can only be assigned to one control option and, as such, there can be a total of only five possible control options) for controlling the device.

As such, improved systems and techniques that provide many control options to a user to control a device (e.g., an XR device, such as in the form of an HMD), while allowing for an accurate detection of hand gestures of the user, can be useful.

In one or more aspects, the systems and techniques provide a mechanism for controlling a device (e.g., an XR device, such as in the form of an HMD device). In one or more aspects, the systems and techniques combine touch gestures with basic hand gestures to provide users with many control options for controlling a device (e.g., an XR device) in an easier and more efficient manner. The combination of the touch and hand gestures together can be used to define more comprehensive control options for controlling the device.

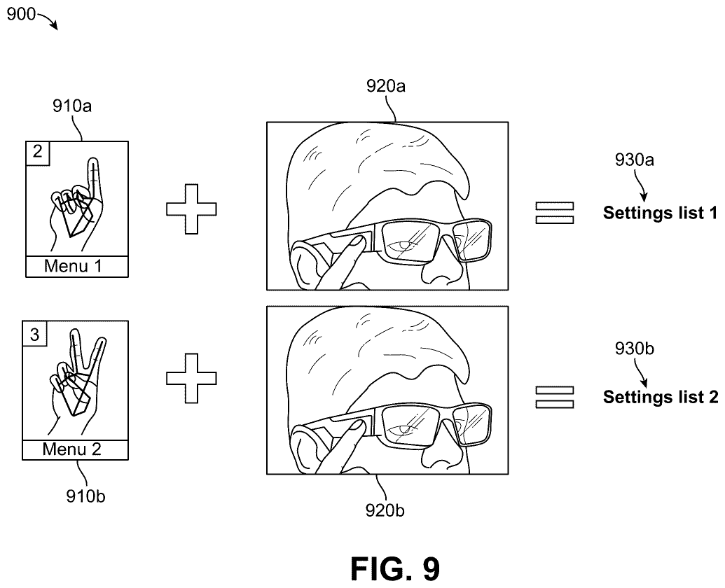

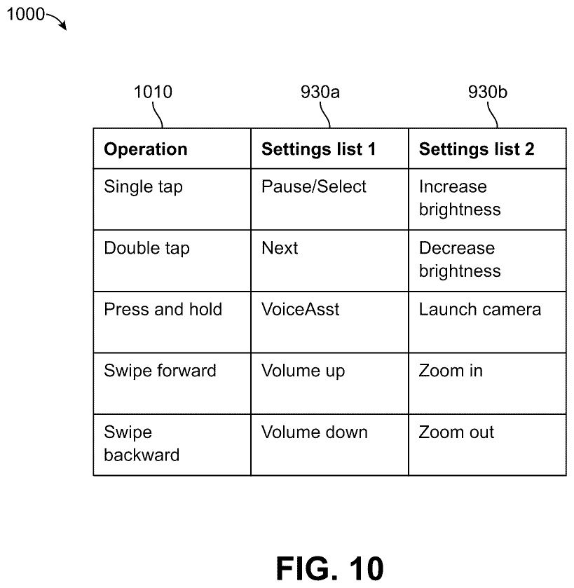

FIG. 9 shows examples of different combinations of touch and hand gestures to enable different control options, which are shown in the table of FIG. 10. In particular, FIG. 9 is a diagram illustrating examples 900 of different combinations of hand gestures and touch gestures to enable different control options (e.g., to control different operations) of a device (e.g., an XR device) that may be in the form of an HMD (e.g., HMD 510 of FIGS. 5A and 5B), and FIG. 10 is a table 1000 illustrating examples of different control options (e.g., control operations) that correspond to the different combinations of hand gestures and touch gestures of FIG. 9.

In one or more examples, a user (e.g., user 710 of FIG. 7) may perform a hand gesture (e.g., hand gesture 910a or hand gesture 910b of FIG. 9) with a hand of the user to indicate a specific setting list (e.g., settings list 1 930a or settings list 2 930b), of a plurality of settings lists, associated with that particular hand gesture. In some examples, a user may perform a gesture of one or more fingers indicating a number (e.g., presenting one or more fingers of the hand of the user to indicate a number corresponding to the number of fingers being presented) that may correspond to a specific settings list (e.g., one finger presented may indicate a number one, which may correspond to a first settings list). For example, the hand gesture 910a of FIG. 9 is shown to be presenting one finger of the hand of the user to indicate a number one, which may correspond to a first settings list (e.g., settings list 1 930a). As another example, the hand gesture 910b of FIG. 9 is shown to be presenting two fingers of the hand of the user to indicate a number two, which may correspond to a second settings list (e.g., settings list 2 930b). As described below, the first settings list and/or the second settings list can be presented (e.g., displayed) by the device to allow the user to execute one or more touch events (e.g., touch gestures) corresponding to one or more commands indicated in the settings list(s).

In some examples, a user (e.g., user 710 of FIG. 7) may perform a hand gesture, which does not indicate a specific number, with a hand of the user to indicate a specific setting list (e.g., settings list 1 930a or settings list 2 930b), of a plurality of settings lists, associated with that particular hand gesture. For example, a hand gesture, which does not specifically indicate a number (e.g., a fist gesture, where the hand of the user being closed in a fist, an open hand, a “C”-shaped hand gesture, etc.), may correspond to a specific settings list (e.g., the fist gesture may correspond to a first settings list, such as settings list 1 930a).

Devices (e.g., XR devices) in the form of HMDs (e.g., HMD 510 of FIG. 5A) often include a touch pad (e.g., touch pad 540 of FIG. 5A). A user may perform a touch gesture (e.g., touch gesture 920a or touch gesture 920b) to control operations (e.g., to perform control options) of the HMD 510 (e.g., XR device). In one or more examples, the user may perform a touch gesture to select a control option from a selected settings list (e.g., settings list 1 930a or settings list 2 930b). The user 520 may perform the touch gesture by touching the touch pad (e.g., touch pad 540 of FIG. 5A) with a hand (e.g., via one or more fingers of the hand) of the user.

In one or more examples, the touch gestures may include, but are not limited to, a single tap operation (e.g., where the user taps the touch pad with a single finger once), a double tap operation (e.g., where the user taps the touch pad with a single finger twice), a press and hold operation (e.g., where the user touches the touch pad and holds the touch to the touch pad for a duration of time with a single finger), a swipe forward operation (e.g., where the user swipes the touch pad, with a single finger, in a forward direction, from the back of the head of the user towards the face of the user), and/or a swipe backward operation (e.g., where the user swipes the touch pad, with a single finger, in a backward direction, from the face of the user towards the back of the head of the user).

In one or more examples, the control options (e.g., operations) may include, but are not limited to, a pause operation (e.g., to pause a video and/or audio being played by the device), a select operation (e.g., to select an option being presented by the device to the user), a next operation (e.g., to move to another screen or another object being presented by the device to the user), a voice assist operation (e.g., to invoke voice assistance by the device for the user), a volume up operation (e.g., to increase the volume in audio controlled by the device), a volume down operation (e.g., to decrease the volume in the audio controlled by the device), an increase brightness operation (e.g., to increase the brightness in the display controlled by the device), a decrease brightness operation (e.g., to decrease the brightness in the display controlled by the device), a launch camera operation (e.g., to launch a camera controlled by the device), a zoom in operation (e.g., to zoom in on an image displayed on a display controlled by the device, and/or a zoom out operation (e.g., to zoom out of an image displayed on the display controlled by the device).

In one or more examples, a user may perform a combination of a hand gesture (e.g., hand gesture 910a or hand gesture 910b) and a touch gesture (e.g., touch gesture 920a or touch gesture 920b) to enable a specific control option. For example, the user may perform hand gesture 910a (e.g., to present a single finger to indicate a number one) to invoke the settings list 1 930a. In combination with hand gesture 910a, the user may also perform the touch gesture 920a (e.g., a single tap) to select the pause/select control option of the settings list 1 930a. For another example, the user may perform a touch gesture 920b (e.g., to present two figures to indicate a number two) to invoke the settings list 2 930b. In combination with touch gesture 910b, the user may also perform the touch gesture 920b (e.g., a double tap) to select the decrease brightness control option of the settings list 2 930b.

In one or more examples, the user may perform the hand gesture (e.g., hand gesture 910a) to invoke the specific settings list (e.g., settings list 1 930a) just prior to performing the touch gesture (e.g., touch gesture 920b) to select the specific control option (e.g., pause/select control option) from the settings list (e.g., settings list 1 930a). In some examples, the user may simultaneously perform the hand gesture (e.g., hand gesture 910a) and the touch gesture (e.g., touch gesture 920a) such that the hand gesture and the touch gesture occur simultaneously.

In FIG. 10, the table 1000 is shown to include an operations 1010 column that includes different touch gestures, a settings list 1 930a column that includes different control options that correspond to the different touch gestures when the settings list 1 930a is invoked by the user, and a settings list 2 930a column that includes different control options that correspond to the different touch gestures when the settings list 2 930b is invoked by the user. In one or more examples, the table 1000 may include more or less number of settings lists than as shown in FIG. 10.

The different touch gestures of the table 1000 are shown to include a single tap operation, a double tap operation, a press and hold operation, a swipe forward operation, and/or a swipe backward operation. In one or more examples, more or less number of touch gestures and/or different touch gestures may be employed than the touch gestures shown in the operations 1010 column of the table 1000 of FIG. 10. The different control options in the settings list 1 930a column are shown to include a pause/select operation, a next operation, a voice assist operation, a volume up operation, and/or a volume down operation. The different control options in the settings list 2 930b column are shown to include an increase brightness operation, a decrease brightness operation, a launch camera operation, a zoom in operation, and a zoom out operation. In one or more examples, more or less number of control options and/or different control options may be employed than the control options shown in the settings list 1 930a column and/or the settings list 2 930b column of the table 1000 of FIG. 10.

In some examples, the systems and techniques can combine firsthand gestures (e.g., by a first hand of a user) with second hand gestures (e.g., by the first hand or a second hand of the user) to provide a user with many control options for controlling a device (e.g., an XR device) in a more easy and efficient manner. The combination of the first hand gestures and the second hand gestures together can be used to define more comprehensive control options for controlling the device.

As previously mentioned, recognition of hand gestures (e.g., hand gesture controls, such as fist closures, directional hand waves, quick hand swipes, pinch movements, etc.) may not always be accurate, as some users may perform the hand gestures in a slightly incorrect manner such that the hand gestures are not able to be recognized by the device and, as such, the actions associated with the hand gestures are not enabled by the device to occur. In one or more examples, the systems and techniques employ hand gestures of one or more fingers to indicate a number (e.g., presenting one or more fingers of the hand of a user to indicate a number corresponding to the number of fingers being presented) that can correspond to a specific settings list (e.g., one finger presented may indicate a number one, which may correspond to a first settings list). Currently, there are efficient hand-tracking cameras that can easily and accurately read the number of fingers being presented by the user.

FIG. 11 is a diagram illustrating examples of different hand gestures (e.g., hand gesture 1110, hand gesture 1120, and hand gesture 1130) that each indicate a different number, which can be associated with a specific settings list (e.g., a specific menu). In FIG. 11, hand gesture 1110 shows the hand of the user presenting one finger and, as such, hand gesture 1110 can be associated (e.g., by the device, such as an XR device) with the number one (e.g., which may be associated with a first settings list, such as menu 1). Hand gesture 1120 shows the hand of the user presenting two fingers and, as such, hand gesture 1120 can be associated with the number two (e.g., which may be associated with a second settings list, such as menu 2). Hand gesture 1130 shows the hand of the user presenting three fingers and, as such, hand gesture 1130 can be associated with the number three (e.g., which may be associated with a third settings list, such as menu 3).

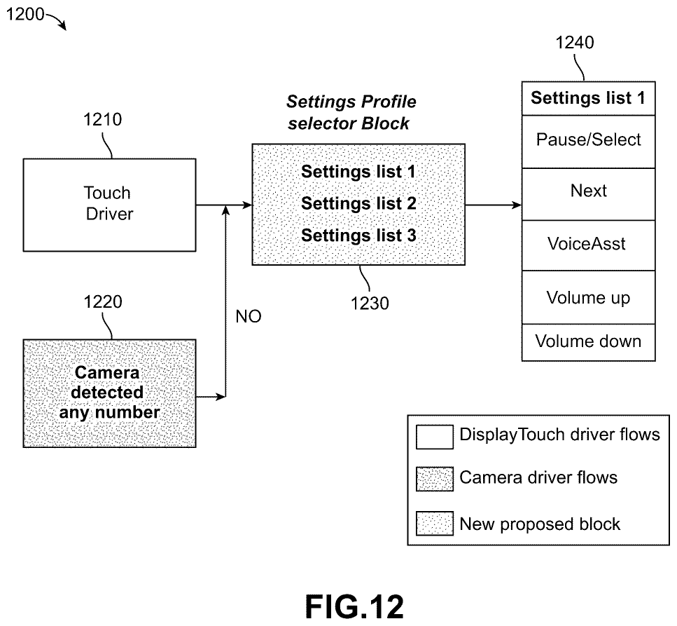

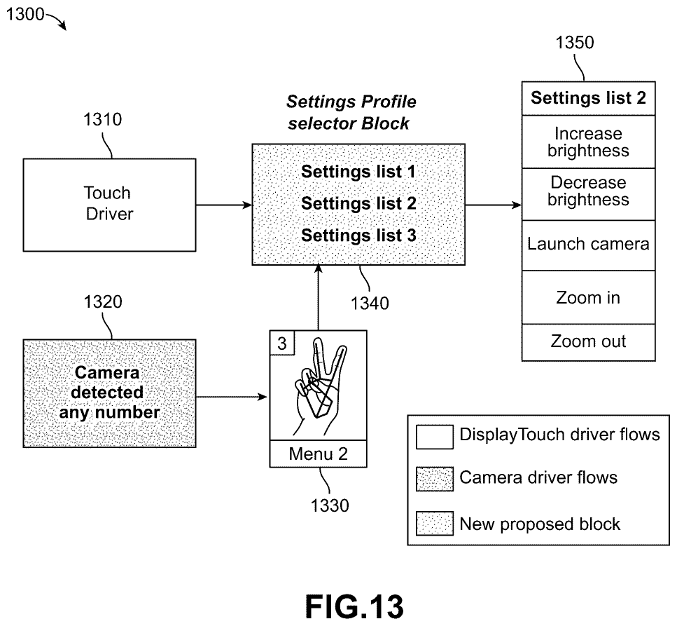

FIGS. 12 and 13 show examples of processes for controlling a device (e.g., an XR device), which may be in the form of an HMD (e.g., HMD 510 of FIGS. 5A and 5B). In particular, FIG. 12 is a diagram illustrating an example of a process 1200 for controlling a device, where no number is detected and a default settings list (e.g., settings list 1 1240) is invoked.

During operation of the process 1200 of FIG. 12, at block 1210, a control gesture (e.g., a touch gesture or, alternatively, a hand gesture) of a plurality of control gestures (e.g., a plurality of touch gestures or a plurality of hand gestures) of a user may be detected using a touch pad or using one or more sensors. In one or more examples, each sensor of the one or more sensors may be a camera, which may be in the form of a red, green, blue (RGB) camera or a monochrome camera.

For example, a touch pad of the device may detect the control gesture, which is in the form of a touch gesture. In one or more examples, the touch gesture may be a single tap operation, a double tap operation, a press and hold operation, a swipe operation, a forward operation, or a backward operation.

For another example, one or more sensors (e.g., one or more cameras) may detect the control gesture, which is in the form of a hand gesture. In one or more examples, the hand gesture may be a gesture of one or more fingers indicating a number, a fist gesture, a hand waving gesture, a pinching gesture, or a hand movement gesture to form a shape (e.g., a circle, square, or triangle).

In one or more examples, the touch pad (e.g., touch pad 540 of FIG. 5A) may be implemented within the device (e.g., an XR device in the form of an HMD, such as HMD 510 of FIGS. 5A and 5B). In some examples, the one or more cameras may be implemented within the device (e.g., HMD 510 of FIGS. 5A and 5B) itself and/or another device, such as a mobile phone (e.g., mobile handset 650 of FIGS. 6A and 6B). In one or more examples, the device and the other device (e.g., mobile phone) may communicate with each other via a wireless communication protocol (e.g., Bluetooth protocol).

In one or more examples, each control option, of the plurality of control options, may be associated with a different control gesture (e.g., a unique control gesture) of the plurality of control gestures. In one or more examples, each control option of the plurality of control options may be a pause operation, a select operation, a next operation, a voice assist operation, a volume up operation, a volume down operation, an increase brightness operation, a decrease brightness operation, a launch camera operation, a zoom in operation, or a zoom out operation.

For the example shown in FIG. 12, at block 1220, one or more sensors (e.g., one or more cameras) do not detect a first hand gesture. Since no first hand gesture is detected, at block 1230, one or more processors (e.g., which may be implemented within the device and/or another device, such as a mobile phone), may determine to invoke a default settings list (e.g., a first settings list, such as setting list 1 1240) of a plurality of settings lists. In one or more examples, the default settings list may include the plurality of control options (e.g., a pause/select operation, a next operation, a voice assist operation, a volume up operation, and a volume down operation). The one or more processors may determine a first control option of the plurality of control options in the default settings list based on the detected control gesture. The one or more processors may then enable the first control option to control the device.

FIG. 13 is a diagram illustrating an example of a process 1300 for controlling a device, where a number two (2) is detected and an associated second settings list (e.g., settings list 2 1350) is invoked. During operation of the process 1300 of FIG. 13, at block 1310, a control gesture (e.g., a touch gesture or, alternatively, a hand gesture) of a plurality of control gestures (e.g., a plurality of touch gestures or a plurality of hand gestures) of a user may be detected using a touch pad or using one or more sensors (e.g., each sensor may be a camera, which may be in the form of a RGB camera or a monochrome camera).

For example, a touch pad of the device may detect the control gesture, which is in the form of a touch gesture. The touch gesture can be a single tap operation, a double tap operation, a press and hold operation, a swipe operation, a forward operation, or a backward operation. For another example, one or more sensors (e.g., one or more cameras) may detect the control gesture, which is in the form of a hand gesture. The hand gesture can be a gesture of one or more fingers indicating a number, a fist gesture, a hand waving gesture, a pinching gesture, or a hand movement gesture to form a shape (e.g., a circle, square, or triangle).

In one or more examples, the touch pad (e.g., touch pad 540 of FIG. 5A) can be implemented within the device, such as an XR device, which may be in the form of an HMD, such as HMD 510 of FIGS. 5A and 5B. The one or more cameras may be implemented within the device (e.g., HMD 510 of FIGS. 5A and 5B) itself and/or another device, such as a mobile phone (e.g., mobile handset 650 of FIGS. 6A and 6B). In some examples, the device and the other device (e.g., mobile phone) may communicate with each other via a wireless communication protocol, such as a Bluetooth protocol.

In one or more examples, each control option, of the plurality of control options, can be associated with a different control gesture (e.g., a unique control gesture) of the plurality of control gestures. Each control option of the plurality of control options can be a pause operation, a select operation, a next operation, a voice assist operation, a volume up operation, a volume down operation, an increase brightness operation, a decrease brightness operation, a launch camera operation, a zoom in operation, or a zoom out operation.

During operation of the process 1300, at block 1320, the one or more sensors (e.g., the one or more cameras) may detect a first hand gesture of a plurality of first hand gestures of a user. In one or more examples, the detecting of the control gesture and the detecting of the first hand gesture occur simultaneously. In one or more examples, each hand gesture of the plurality of first hand gestures may be a gesture of one or more fingers indicating a number, a fist gesture, a hand waving gesture, a pinching gesture, or a hand movement gesture to form a shape (e.g., a circle, square, or triangle).

At block 1340, one or more processors (e.g., which may be implemented within the device and/or another device, such as a mobile phone) may determine a first settings list of a plurality of settings lists based on the detected first hand gesture. In one or more examples, the first settings list includes the plurality of control options. Each settings list of the plurality of settings lists may be associated with a respective hand gesture.

In one or more examples, the one or more processors may determine a first number associated with the first hand gesture. For the example shown in FIG. 13, the one or more processors may determine that the first hand gesture is a gesture of presenting two fingers 1330 and, as such, the one or more processors may determine that the first number associated with the first hand gesture is two.

In one or more examples, each settings list of a plurality of settings lists may be associated with a respective number. The one or more processors may determine the first settings list (e.g., settings list 2 1350) based on the first number (e.g., two) and, as such, the one or more processors may invoke the settings list 2 1350 of the plurality of settings lists. In one or more examples, the settings list 2 1350 may include the plurality of control options (e.g., an increase brightness operation, a decrease brightness operation, a launch camera operation, a zoom in operation, and a zoom out operation). The one or more processors may determine a first control option of the plurality of control options in the settings list 2 1350 based on the detected control gesture. The one or more processors may then enable the first control option to control the device.

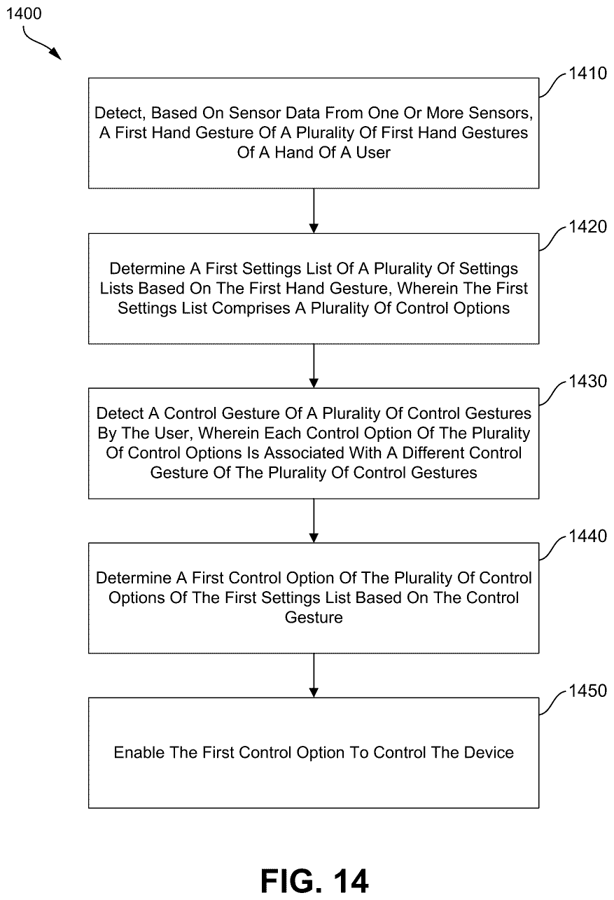

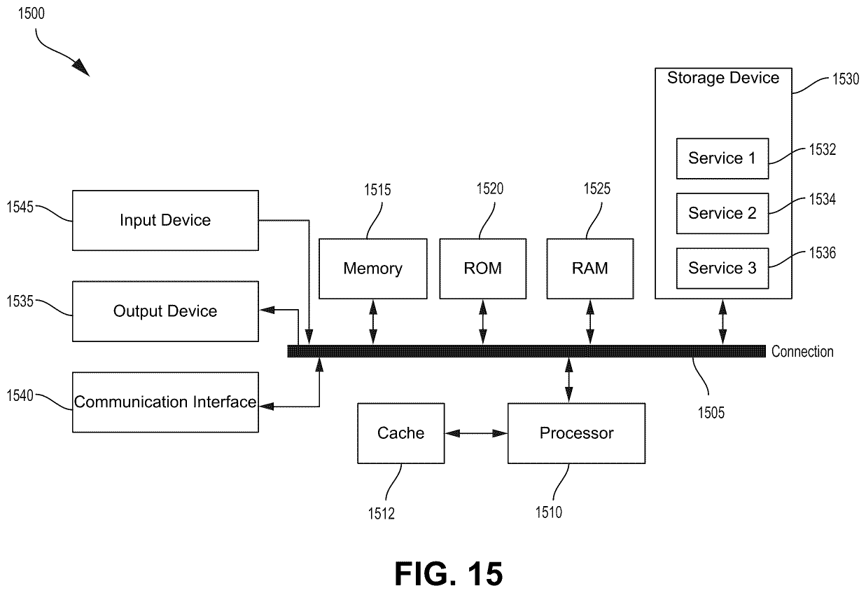

FIG. 14 is a flow chart illustrating an example of a process 1400 for controlling a device. The process 1400 can be performed by a computing device (or apparatus), or by a component or system (e.g., a chipset, one or more processors such as one or more CPUs, GPUs, NPUs, DSPs, etc., or other component or system) of the computing device. In some aspects, the computing device is an extended reality (XR) device (e.g., an augmented reality (AR), virtual reality (VR), and/or mixed reality (MR) device). For instance, the XR device can be a head-mounted display (HMD) device. The operations of the process 1400 may be implemented as software components that are executed and run on one or more processors (e.g., processor 1510 of FIG. 15 or other processor(s)).

At block 1410, the computing device (or component thereof) can detect, based on sensor data from one or more sensors, a first hand gesture of a plurality of first hand gestures of a user. In some aspects, each sensor of the one or more sensors is one of a red, green, blue (RGB) camera sensor or a monochrome camera sensor. In some examples, the plurality of first hand gestures includes a gesture of one or more fingers indicating a number, a fist gesture, a hand waving gesture, a pinching gesture, a hand movement gesture to form a shape, any combination thereof, and/or other hand gestures.

In some cases, each sensor of the one or more sensors is implemented within one of the computing device or an additional device (e.g., a mobile phone, a tablet computer, a wearable device such as a network-connected watch, or other device). For instance, in some examples, the computing device can include the one or more sensors. In some aspects, the computing device can include at least one memory and at least one processor. The additional device can also include at least one processor. In some cases, the at least one processor of the additional device can perform one or more operations of the process 1400. In some aspects, the computing device and the additional device can communicate with each other via a wireless communication protocol (e.g., a Bluetooth™ protocol or other type of wireless communication protocol).

At block 1420, the computing device (or component thereof) can determine a first settings list of a plurality of settings lists based on the first hand gesture. The first settings list includes a plurality of control options. In some examples, the plurality of control options can include a pause operation, a select operation, a next operation, a voice assist operation, a volume up operation, a volume down operation, an increase brightness operation, a decrease brightness operation, a launch camera operation, a zoom in operation, a zoom out operation, any combination thereof, and/or other control options. In some aspects, each settings list of the plurality of settings lists is associated with a respective hand gesture. In some cases, each settings list of the plurality of settings lists is associated with a respective number. For example, the computing device (or component thereof) can determine a first number associated with the first hand gesture. In such an example, the computing device (or component thereof) can determine the first settings list of the plurality of settings lists based on the first number.

At block 1430, the computing device (or component thereof) can detect a control gesture of a plurality of control gestures by the user. In some cases, the computing device (or component thereof) can detect the control gesture and the first hand gesture simultaneously. Each control gesture of the plurality of control gestures is associated with a different control option of the plurality of control options. In one illustrative example, the control gesture is a touch gesture of a plurality of touch gestures. For instance, the plurality of touch gestures can include a single tap operation, a double tap operation, a press and hold operation, a swipe forward operation, a swipe backward operation, any combination thereof, and/or other touch gestures. In such an example, to detect the control gesture, the computing device (or component thereof) can detect, via a touch pad of the computing device, the touch gesture of the user. In another illustrative example, the control gesture is a second hand gesture of a plurality of second hand gestures. In such an example, to detect the control gesture, the computing device (or component thereof) can detect the second hand gesture of one of a hand of the user performing the first hand gesture or another hand of the user.

At block 1440, the computing device (or component thereof) can determine a first control option of the plurality of control options of the first settings list based on the control gesture. At block 1450, the computing device (or component thereof) can enable the first control option to control the computing device.

In some examples, the process 1400 may be performed by one or more computing devices or apparatuses. In some illustrative examples, the process 1400 can be performed by the image capture and processing system 100 of FIG. 1, the XR system 200 of FIG. 2, and/or one or more computing devices or systems (e.g., the computing system 1500 of FIG. 15). In some cases, such a computing device or apparatus may include a processor, microprocessor, microcomputer, or other component of a device that is configured to carry out the steps of the process 1400. In some examples, such computing device or apparatus may include one or more sensors configured to capture image data. For example, the computing device can include a smartphone, a head-mounted display, a mobile device, a camera, a tablet computer, or other suitable device. In some examples, such computing device or apparatus may include a camera configured to capture one or more images or videos. In some cases, such computing device may include a display for displaying images. In some examples, the one or more sensors and/or camera are separate from the computing device, in which case the computing device receives the sensed data. Such computing device may further include a network interface configured to communicate data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1400 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1400 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 15 is a block diagram illustrating an example of a computing system 1500, which may be employed by the disclosed system for DRV enhancements for dynamic FPS use cases. In particular, FIG. 15 illustrates an example of computing system 1500, which can be for example any computing device making up internal computing system, a remote computing system, a camera, or any component thereof in which the components of the system are in communication with each other using connection 1505. Connection 1505 can be a physical connection using a bus, or a direct connection into processor 1510, such as in a chipset architecture. Connection 1505 can also be a virtual connection, networked connection, or logical connection.

In some aspects, computing system 1500 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1500 includes at least one processing unit (CPU or processor) 1510 and connection 1505 that communicatively couples various system components including system memory 1515, such as read-only memory (ROM) 1520 and random access memory (RAM) 1525 to processor 1510. Computing system 1500 can include a cache 1512 of high-speed memory connected directly with, in close proximity to, or integrated as part of processor 1510.

Processor 1510 can include any general purpose processor and a hardware service or software service, such as services 1532, 1534, and 1536 stored in storage device 1530, configured to control processor 1510 as well as a special-purpose processor where software instructions are incorporated into the actual processor design. Processor 1510 may essentially be a completely self-contained computing system, containing multiple cores or processors, a bus, memory controller, cache, etc. A multi-core processor may be symmetric or asymmetric.

To enable user interaction, computing system 1500 includes an input device 1545, which can represent any number of input mechanisms, such as a microphone for speech, a touch-sensitive screen for gesture or graphical input, keyboard, mouse, motion input, speech, etc. Computing system 1500 can also include output device 1535, which can be one or more of a number of output mechanisms. In some instances, multimodal systems can enable a user to provide multiple types of input/output to communicate with computing system 1500.

Computing system 1500 can include communications interface 1540, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1540 may also include one or more range sensors (e.g., LIDAR sensors, laser range finders, RF radars, ultrasonic sensors, and infrared (IR) sensors) configured to collect data and provide measurements to processor 1510, whereby processor 1510 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1540 may also include one or more Global Navigation Satellite System (GNSS) receivers or transceivers that are used to determine a location of the computing system 1500 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1530 can include software services, servers, services, etc., that when the code that defines such software is executed by the processor 1510, it causes the system to perform a function. In some aspects, a hardware service that performs a particular function can include the software component stored in a computer-readable medium in connection with the necessary hardware components, such as processor 1510, connection 1505, output device 1535, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for enabling one or more control options, the apparatus comprising: at least one memory; and at least one processor coupled to the at least one memory and configured to: detect, based on sensor data from one or more sensors, a first hand gesture of a plurality of first hand gestures of a user; determine a first settings list of a plurality of settings lists based on the first hand gesture, wherein the first settings list comprises a plurality of control options; detect a control gesture of a plurality of control gestures by the user, wherein each control gesture of the plurality of control gestures is associated with a different control option of the plurality of control options; determine a first control option of the plurality of control options of the first settings list based on the control gesture; and enable the first control option to control the apparatus.

Aspect 2. The apparatus of Aspect 1, wherein: the control gesture is a touch gesture of a plurality of touch gestures; and to detect the control gesture, the at least one processor is configured to detect, via a touch pad of the apparatus, the touch gesture of the user.

Aspect 3. The apparatus of Aspect 2, wherein each touch gesture of the plurality of touch gestures is one of a single tap operation, a double tap operation, a press and hold operation, a swipe forward operation, or a swipe backward operation.

Aspect 4. The apparatus of any one of Aspects 1 to 3, wherein: the control gesture is a second hand gesture of a plurality of second hand gestures; and to detect the control gesture, the at least one processor is configured to detect the second hand gesture of one of a hand performing the first hand gesture or another hand of the user.

Aspect 5. The apparatus of any one of Aspects 1 to 4, wherein each control option of the plurality of control options is one of a pause operation, a select operation, a next operation, a voice assist operation, a volume up operation, a volume down operation, an increase brightness operation, a decrease brightness operation, a launch camera operation, a zoom in operation, or a zoom out operation.

Aspect 6. The apparatus of any one of Aspects 1 to 5, wherein each settings list of the plurality of settings lists is associated with a respective hand gesture.

Aspect 7. The apparatus of any one of Aspects 1 to 6, wherein each hand gesture of the plurality of first hand gestures is one of a gesture of one or more fingers indicating a number, a fist gesture, a hand waving gesture, a pinching gesture, or a hand movement gesture to form a shape.

Aspect 8. The apparatus of any one of Aspects 1 to 7, wherein the at least one processor is configured to determine a first number associated with the first hand gesture.

Aspect 9. The apparatus of Aspect 8, wherein: the at least one processor is configured to determine the first settings list of the plurality of settings lists based on the first number; and each settings list of the plurality of settings lists is associated with a respective number.

Aspect 10. The apparatus of any one of Aspects 1 to 9, wherein the at least one processor is configured to detect the control gesture and the first hand gesture simultaneously.

Aspect 11. The apparatus of any one of Aspects 1 to 10, wherein each sensor of the one or more sensors is one of a red, green, blue (RGB) camera sensor or a monochrome camera sensor.

Aspect 12. The apparatus of any one of Aspects 1 to 11, wherein each sensor of the one or more sensors is implemented within one of the apparatus or an additional device.

Aspect 13. The apparatus of Aspect 12, wherein the apparatus and the additional device communicate with each other via a wireless communication protocol.

Aspect 14. The apparatus of Aspect 13, wherein the wireless communication protocol is a Bluetooth protocol.

Aspect 15. The apparatus of any one of Aspects 12 to 14, wherein the additional device is a mobile phone.

Aspect 16. The apparatus of any one of Aspects 1 to 15, wherein the apparatus is an extended reality (XR) device.

Aspect 17. The apparatus of Aspect 16, wherein the XR device is a head-mounted display (HMD) apparatus.

Aspect 18. The apparatus of any one of Aspects 1 to 17, further comprising the one or more sensors.

Aspect 19. A method for controlling a device, the method comprising: detecting, using one or more sensors, a first hand gesture of a plurality of first hand gestures of a user; determining, by one or more processors, a first settings list of a plurality of settings lists based on the first hand gesture, wherein the first settings list comprises a plurality of control options; detecting a control gesture of a plurality of control gestures by the user, wherein each control gesture of the plurality of control gestures is associated with a different control option of the plurality of control options; determining, by the one or more processors, a first control option of the plurality of control options of the first settings list based on the control gesture; and enabling, by the one or more processors, the first control option to control the device.

Aspect 20. The method of Aspect 19, wherein: the control gesture is a touch gesture of a plurality of touch gestures; and the detecting of the control gesture comprises detecting, via a touch pad of the device, the touch gesture of the user.

Aspect 21. The method of Aspect 20, wherein each touch gesture of the plurality of touch gestures is one of a single tap operation, a double tap operation, a press and hold operation, a swipe forward operation, or a swipe backward operation.

Aspect 22. The method of any one of Aspects 19 to 21, wherein: the control gesture is a second hand gesture of a plurality of second hand gestures; and the detecting of the control gesture comprises detecting, using the one or more sensors, the second hand gesture of one of a hand performing the first hand gesture or another hand of the user.

Aspect 23. The method of any one of Aspects 19 to 22, wherein each control option of the plurality of control options is one of a pause operation, a select operation, a next operation, a voice assist operation, a volume up operation, a volume down operation, an increase brightness operation, a decrease brightness operation, a launch camera operation, a zoom in operation, or a zoom out operation.

Aspect 24. The method of any one of Aspects 19 to 23, wherein each settings list of the plurality of settings lists is associated with a respective hand gesture.

Aspect 25. The method of any one of Aspects 19 to 24, wherein each hand gesture of the plurality of first hand gestures is one of a gesture of one or more fingers indicating a number, a fist gesture, a hand waving gesture, a pinching gesture, or a hand movement gesture to form a shape.

Aspect 26. The method of any one of Aspects 19 to 25, further comprising determining, by the one or more processors, a first number associated with the first hand gesture.

Aspect 27. The method of Aspect 26, wherein: the determining, by the one or more processors, of the first settings list of the plurality of settings lists is based on the first number; and each settings list of the plurality of settings lists is associated with a respective number.

Aspect 28. The method of any one of Aspects 19 to 27, wherein detecting the control gesture and detecting the first hand gesture occur simultaneously.

Aspect 29. The method of any one of Aspects 19 to 28, wherein each sensor of the one or more sensors is one of a red, green, blue (RGB) camera sensor or a monochrome camera sensor.

Aspect 30. The method of any one of Aspects 19 to 29, wherein each sensor of the one or more sensors is implemented within one of the device or an additional device.

Aspect 31. The method of Aspect 30, wherein the device and the additional device communicate with each other via a wireless communication protocol.

Aspect 32. The method of Aspect 31, wherein the wireless communication protocol is a Bluetooth protocol.

Aspect 33. The method of any one of Aspects 30 to 32, wherein the additional device is a mobile phone.

Aspect 34. The method of any one of Aspects 19 to 33, wherein the device is an extended reality (XR) device.

Aspect 35. The method of Aspect 34, wherein the XR device is a head-mounted display (HMD) device.

Aspect 36. The method of any one of Aspects 19 to 35, wherein each processor of the one or more processors is implemented within one of the device or another device.

Aspect 37. A non-transitory computer-readable medium having stored thereon instructions that, when executed by one or more processors, cause the one or more processors to perform operations according to any of Aspects 19 to 36.

Aspect 38. An apparatus including one or more means for performing operations according to any of Aspects 19 to 36.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for enabling one or more control options, the apparatus comprising:
at least one memory; and
at least one processor coupled to the at least one memory and configured to:
detect, based on sensor data from one or more sensors, a first hand gesture of a plurality of first hand gestures of a user;
determine a first settings list of a plurality of settings lists based on the first hand gesture, wherein the first settings list comprises a plurality of control options;
detect a control gesture of a plurality of control gestures by the user, wherein each control gesture of the plurality of control gestures is associated with a different control option of the plurality of control options;
determine a first control option of the plurality of control options of the first settings list based on the control gesture; and
enable the first control option to control the apparatus.

2. The apparatus of claim 1, wherein:
the control gesture is a touch gesture of a plurality of touch gestures; and
to detect the control gesture, the at least one processor is configured to detect, via a touch pad of the apparatus, the touch gesture of the user.

3. The apparatus of claim 2, wherein each touch gesture of the plurality of touch gestures is one of a single tap operation, a double tap operation, a press and hold operation, a swipe forward operation, or a swipe backward operation.

4. The apparatus of claim 1, wherein:
the control gesture is a second hand gesture of a plurality of second hand gestures; and
to detect the control gesture, the at least one processor is configured to detect the second hand gesture of one of a hand performing the first hand gesture or another hand of the user.

5. The apparatus of claim 1, wherein each control option of the plurality of control options is one of a pause operation, a select operation, a next operation, a voice assist operation, a volume up operation, a volume down operation, an increase brightness operation, a decrease brightness operation, a launch camera operation, a zoom in operation, or a zoom out operation.

6. The apparatus of claim 1, wherein each settings list of the plurality of settings lists is associated with a respective hand gesture.

7. The apparatus of claim 1, wherein each hand gesture of the plurality of first hand gestures is one of a gesture of one or more fingers indicating a number, a fist gesture, a hand waving gesture, a pinching gesture, or a hand movement gesture to form a shape.

8. The apparatus of claim 1, wherein the at least one processor is configured to determine a first number associated with the first hand gesture.

9. The apparatus of claim 8, wherein:
the at least one processor is configured to determine the first settings list of the plurality of settings lists based on the first number; and
each settings list of the plurality of settings lists is associated with a respective number.

10. The apparatus of claim 1, wherein the at least one processor is configured to detect the control gesture and the first hand gesture simultaneously.

11. The apparatus of claim 1, wherein each sensor of the one or more sensors is one of a red, green, blue (RGB) camera sensor or a monochrome camera sensor.

12. The apparatus of claim 1, wherein each sensor of the one or more sensors is implemented within one of the apparatus or an additional device.

13. The apparatus of claim 12, wherein the apparatus and the additional device communicate with each other via a wireless communication protocol.

14. The apparatus of claim 13, wherein the wireless communication protocol is a Bluetooth protocol.

15. The apparatus of claim 12, wherein the additional device is a mobile phone.

16. The apparatus of claim 1, wherein the apparatus is an extended reality (XR) device.

17. The apparatus of claim 16, wherein the XR device is a head-mounted display (HMD) apparatus.

18. The apparatus of claim 1, further comprising the one or more sensors.

19. A method for controlling a device, the method comprising:
detecting, using one or more sensors, a first hand gesture of a plurality of first hand gestures of a user;
determining, by one or more processors, a first settings list of a plurality of settings lists based on the first hand gesture, wherein the first settings list comprises a plurality of control options;
detecting a control gesture of a plurality of control gestures by the user, wherein each control gesture of the plurality of control gestures is associated with a different control option of the plurality of control options;
determining, by the one or more processors, a first control option of the plurality of control options of the first settings list based on the control gesture; and
enabling, by the one or more processors, the first control option to control the device.

20. The method of claim 19, wherein:
the control gesture is a touch gesture of a plurality of touch gestures; and
the detecting of the control gesture comprises detecting, via a touch pad of the device, the touch gesture of the user.

21. The method of claim 19, wherein:
the control gesture is a second hand gesture of a plurality of second hand gestures; and
the detecting of the control gesture comprises detecting, using the one or more sensors, the second hand gesture of one of a hand performing the first hand gesture or another hand of the user.

22. The method of claim 19, wherein each control option of the plurality of control options is one of a pause operation, a select operation, a next operation, a voice assist operation, a volume up operation, a volume down operation, an increase brightness operation, a decrease brightness operation, a launch camera operation, a zoom in operation, or a zoom out operation.

23. The method of claim 19, wherein each settings list of the plurality of settings lists is associated with a respective hand gesture.

24. The method of claim 19, wherein each hand gesture of the plurality of first hand gestures is one of a gesture of one or more fingers indicating a number, a fist gesture, a hand waving gesture, a pinching gesture, or a hand movement gesture to form a shape.

25. The method of claim 19, further comprising determining, by the one or more processors, a first number associated with the first hand gesture.

26. The method of claim 25, wherein:
the determining, by the one or more processors, of the first settings list of the plurality of settings lists is based on the first number; and
each settings list of the plurality of settings lists is associated with a respective number.

27. The method of claim 19, wherein detecting the control gesture and detecting the first hand gesture occur simultaneously.

28. The method of claim 19, wherein each sensor of the one or more sensors is implemented within one of the device or an additional device.

29. The method of claim 19, wherein the device is an extended reality (XR) device.

30. The method of claim 19, wherein each processor of the one or more processors is implemented within one of the device or another device.
